(19) United States
(12) Patent Application Publication
(10) Pub. No.: US 2025/0171879 A1
(43) Pub. Date: May 29, 2025

(54) METHOD FOR RECOVERING RARE EARTH ELEMENTS AND OTHER PRODUCTS FROM ASH

(71) Applicant: GEORGIA TECH RESEARCH CORPORATION, Atlanta, GA (US)

(72) Inventors: Yuanzhi Tang, Atlanta, GA (US); Pan LIU, Falmouth, MA (US)

(21) Appl. No.: 18/836,636

(22) PCT Filed: Feb. 6, 2023
(86) PCT No.: PCT/US2023/012429

§ 371 Date: Aug. 7, 2024

Related U.S. Application Data
(60) Provisional application No. 63/307,568, filed on Feb. 7, 2022.

(51) Int. Cl. C22B 59/00; C01B 39/02; C22B 3/02; C22B 3/24; C22B 3/44; C22B 7/00

(52) U.S. Cl. CPC C22B 59/00; C01B 39/02; C22B 3/02; C22B 3/24; C22B 3/44; C22B 7/007; C01P 2002/72; C01P 2004/03

(57) ABSTRACT

Disclosed herein are systems and methods relating to simultaneous waste processing and recovery of rare earth elements from a waste ash source. In some examples, the method includes contacting a REE-containing waste ash source with a chelating agent, thereby forming a leachate comprising one or more REE and a first residual material; contacting a precipitation agent with the leachate to form a second residual material and a solid precipitate comprising an amount of the one or more REE; separating the solid precipitate from the second residual material; and hydrothermally treating (e.g., using recycled heat or new heat) the first and/or second residual materials under conditions effective to yield a processed material comprising zeolites.

### RELATED APPLICATION

This PCT application claims priority to, and the benefit of, U.S. Provisional Patent Application No. 63/307,568 filed Feb. 7, 2022, which is incorporated by reference herein in its entirety.

### GOVERNMENT LICENSE RIGHTS

This invention was made with government support under contract no. DE-FE0031739 awarded by the National Energy Technology Laboratory (Department of Energy) and under contract no. DE-AR0001394 awarded by the Advanced Research Projects Agency—Energy (Department of Energy). The government has certain rights in the invention.

### BACKGROUND

Rare earth elements (REEs), including lanthanide elements and yttrium, are a valuable component in a diverse set of industries, ranging from consumer electronics to chemical catalysts. Amid unprecedented demand for these elements in recent decades, the global production of REEs has largely stagnated. Current commercial production of REEs occurs from the environmentally-deleterious mining of rare ores such as bastnasite, monazite, and xenotime. Almost half of these deposits are located in a few regions, including China, Russia, the Commonwealth of Independent States, Brazil, and Australia, while more than 90% of the world's REE-production is controlled solely by China.

There has been recent interest in obtaining REEs from alternative sources. REEs are also relatively plentiful in small concentrations in much of the earth's crust. Among these other sources, waste ash byproducts, such as coal fly ash (CFA) and municipal solid waste incineration (MSWI) ash, have been explored as an alternative source largely due to its prevalence. However, current techniques of REE extraction from waste ashes use highly corrosive and expensive solutions, which leave a considerable amount of hazardous secondary waste to be disposed of.

There is a benefit to having systems and methods that can efficiently extract REEs and other chemicals from readily available waste ash sources without producing large amounts of toxic byproducts.

### SUMMARY

Exemplary systems and methods are disclosed for the simultaneous recovery of rare earth elements (REE) and zeolite formation from coal fly ash and industrial/municipal solid waste incineration ash. The systems and methods include a leaching and precipitation process that leaches REE from coal ash using a chelating agent and then precipitates the leached REE as solid products using a precipitation agent. The output includes REEs and other trace metals that can be further processed in downstream purification and production, e.g., REE compounds. The residual streams from the REE recovery process can be combined to synthesize zeolite, a marketable industrial catalyst, and adsorbent, thereby reducing a large amount of secondary waste.

Advantageously, the exemplary systems and methods can use inexpensive and environmentally-sustainable chemicals that are low in acidity and non-toxic to extract both REE and zeolite as marketable products. The process is high efficiency, has high scalability, and generates minimal waste production.

In an aspect, a method is disclosed for recovering rare earth elements (REE) from a waste ash source. The method includes contacting an REE-containing waste ash source (e.g., municipal solid waste incineration ash; coal fly ash) with a chelating agent to form a leachate comprising one or more REE and a first residual material; contacting a precipitation agent with the leachate to form a second residual material and a solid precipitate comprising an amount of the one or more REE; separating the solid precipitate from the second residual material; and hydrothermally treating (e.g., using recycled heat or new heat) the first and/or second residual materials under conditions effective to yield a processed material comprising zeolites.

In some embodiments, the REE-containing waste ash source comprises coal fly ash (CFA), municipal solid waste incineration (MSWI) ash, industrial solid waste incineration ash, or a combination thereof.

In some embodiments, the REE-containing waste ash source comprises coal fly ash (CFA) (e.g., Class C and/or Class F CFA).

In various embodiments, the REE-containing waste ash source comprises 5% or more SiO₂ by weight (e.g., 10 wt % or more SiO₂, 20 wt % or more SiO₂, 30 wt % or more SiO₂, 40 w % or more SiO₂, 50 wt % or more SiO₂, 60 wt % or more SiO₂, 70 wt % or more SiO₂, or 80 wt % or more SiO₂).

In some embodiments, the chelating agent comprises an acid (e.g., an organic acid) or salt thereof. In some embodiments, the chelating agent comprises citric acid or a salt thereof (e.g., microbially synthesized citrate or citric acid). In some embodiments, the citric acid or salt thereof is contacted with the REE-containing waste ash source at a concentration from 25 mM to 150 mM (e.g., from 25 mM to 100 mM, from 25 mM to 50 mM, from 50 mM to 100 mM, or about 50 mM). In some embodiments, the REE-containing waste ash source is contacted with the chelating agent at a pH of 7.0 or less (e.g., 6.0 or less, 5.0 or less, 4.0 or less, 3.0 or less, 2.0 or less, or 1.0 or less).

In some embodiments, the precipitation agent comprises an organic ligand (e.g., oxalic acid or a salt thereof or a microbially synthesized oxalic acid or oxalate). In some embodiments, the solid precipitate comprises an REE-oxalate (e.g., an REE-containing Ca-oxalate).

In some embodiments, the first residual material is contacted with the second residual material prior to or during hydrothermal treatment. In some embodiments, the first and/or second residual material are contacted with an alkaline solution (e.g., NaOH) prior to or during hydrothermal treatment. In various examples, the hydrothermal treating of the first and/or second residual material occurs at a temperature from 50° C. to 300° C. (e.g., from 100° C. to 300° C., 150° C. to 300° C., 200° C. to 300° C., from 50° C. to 250° C., from 50° C. to 200° C., from 100° C. to 200° C., or from 100° C. to 150° C.).

In some embodiments, the method further comprises substantially separating the zeolites from the processed material to form a zeolite-rich product and a depleted waste material.

In some embodiments, the zeolite-rich product comprises 75% or more zeolites by weight (e.g., 80% or more by weight, 85% or more by weight, 90% or more by weight, 95% or more by weight, 97% or more by weight, or 99% or more by weight).

In some embodiments, the method further includes substantially separating a purified REE-product from the solid precipitate.

In some embodiments, the step of substantially separating the purified REE-product comprises dissolving the solid precipitate comprising the amount of one or more REE in a solvent (e.g., nitric acid) and recovering the purified REE-product (e.g., by adsorption/desorption).

In some embodiments, the purified REE-product is adsorbed using functionalized magnetic mesoporous silica particles.

In some embodiments, the method is performed continuously or semi-continuously. In some embodiments, the method is performed batch-wise.

In another aspect, a method is disclosed for processing residual waste ash material. The method includes hydrothermally treating a residual waste ash material (e.g., a solid-liquid heterogeneous mixture) comprising a concentration of aluminosilicates under conditions effective to yield a processed waste ash material comprising zeolites, wherein the residual waste ash material was collected as a byproduct from the removal (e.g., by extraction or leaching) of a heavy metal (e.g., rare earth elements) from a prior process; and substantially separating the zeolites from the processed waste material, thereby forming a zeolite-rich product and a depleted waste material.

In another aspect, a method is disclosed for recovering rare earth elements (REE) from a waste ash source. The method includes contacting an REE-containing waste ash source with a chelating agent to form leachate comprising one or more REE and a first residual material (e.g., a solid material); adding a precipitation agent to the leachate to form a second residual material and a solid precipitate comprising an amount of the one or more REE; separating the solid precipitate from the second residual material (e.g., a liquid material); and using the first and/or second residual materials to produce porous metal oxide particles (e.g., zeolites).

Also disclosed herein is a system comprising components to perform the method described above.

In yet another aspect, a system is disclosed for recovering rare earth elements from an REE-containing waste source. The system includes a first reactor (e.g., a continuous stirred-tank reactor) configured to receive the REE-containing waste ash source and a chelating agent, and wherein the first reactor is configured to produce leachate comprising one or more REE and a first residual material (e.g., a solid material); and a second reactor (e.g., a continuous stirred-tank reactor) configured to receive the leachate and a precipitation agent, wherein the second reactor is configured to produce a second residual material (e.g., a liquid material) and a solid precipitate comprising an amount of the one or more REE.

In some examples, the system includes a third reactor (e.g., an autoclave or high-pressure chemical reactor) configured to receive the first and/or second residual materials, wherein the third reactor operates under conditions effective to produce a processed waste material comprising zeolites.

In some embodiments, the REE-containing waste ash source comprises coal fly ash (CFA), municipal solid waste incineration (MSWI) ash, or a combination thereof. In some examples, the REE-containing waste ash source comprises coal fly ash (CFA) (e.g., Class C and/or Class F CFA).

In some embodiments, the REE-containing waste ash source comprises 5% or more SiO₂ by weight (e.g., 10 wt % or more SiO₂, 20 wt % or more SiO₂, 30 wt % or more SiO₂, 40 wt % or more SiO₂, 50 wt % or more SiO₂, 60 wt % or more SiO₂, 70 wt % or more SiO₂, or 80 wt % or more SiO₂).

In some embodiments, the chelating agent comprises an acid (e.g., an organic acid). In some examples, the chelating agent comprises citric acid or a salt thereof (e.g., microbially synthesized citric acid or citrate). In some embodiments, a concentration of citric acid or salt thereof in the first reactor is from 25 mM to 150 mM, such as from 25 mM to 100 mM, from 25 mM to 50 mM, from 50 mM to 100 mM, or about 50 mM.

In some embodiments, the first reactor is configured to operate at a pH of 7.0 or less (e.g., 6.0 or less, 5.0 or less, 4.0 or less, 3.0 or less, 2.0 or less, or 1.0 or less).

In some embodiments, the precipitation agent comprises an organic ligand (e.g., oxalic acid or a salt thereof or a microbially synthesized oxalic acid or oxalate).

In some embodiments, the solid precipitate comprises an REE-oxalate (e.g., an REE-containing Ca-oxalate).

In some embodiments, the third reactor is configured to operate at a temperature of 50° C. to 300° C. (e.g., from 100° C. to 300° C., 150° C. to 300° C., 200° C. to 300° C., from 50° C. to 250° C., from 50° C. to 200° C., from 100° C. to 200° C., or from 100° C. to 150° C.).

In some embodiments, the system further includes a separation unit configured to receive the solid precipitate and a solvent (e.g., nitric acid), wherein the separation unit produces a purified REE-product and a third residual material. In some examples, the separation unit comprises an adsorption column or reactor comprising an adsorbent (e.g., functionalized magnetic mesoporous silica particles).

In some embodiments, the third reactor is configured to receive the first, second, and third residual materials.

In some embodiments, the system is configured to operate continuously or semi-continuously. In some embodiments, the system is configured to operate batch-wise.

### BRIEF DESCRIPTION OF THE DRAWINGS

The skilled person in the art will understand that the drawings described below are for illustration purposes only.

FIG. 1 shows a schematic diagram of a system configured to simultaneously extract rare earth elements (REE) and process secondary waste.

FIG. 2 shows a process flow diagram depicting the conversion of municipal waste to rare earth elements (REE) and zeolites.

FIGS. 3A-3E show schematic diagrams illustrating systems and components for the conversion of a waste ash material to rare earth elements and zeolites.

FIGS. 4A-4C show example flow diagrams depicting methods for extracting rare earth elements (REE) (FIGS. 4A and 4B) and for forming zeolites (FIGS. 4B and 4C).

FIGS. 5A-5D show process flow diagrams illustrating the conversion of waste byproducts from waste combustor facilities (FIGS. 5A and 5B) and coal power plants (FIGS. 5C and 5D) into rare earth elements (REE) and zeolites.

FIGS. 6A-6B shows XRD patterns of the raw coal fly ash(CFA) samples and products for F-1 CFA (FIG. 6A) and C-1 CFA (FIG. 6B). From top to bottom: (1) raw CFA samples, (2) CFA samples after citrate leaching (pH 4.0, 50 mM citrate, and liquid-to-solid ratio of 200 mL/g), (3) REE-rich oxalate products after oxalate precipitation, and (4) zeolite products after synthesis at 150° C. Vertical gray shadings indicate dissolved mineral phases after citrate leaching. Also shown are powder diffraction standards: hydroxy-sodalite ([Na1.08Al2Si1.68O7.44 1.8H2O], PDF 31-1271), tobermorite ([Ca5(OH)2Si6O16·4H2O], PDF 19-1364), and weddellite ([CaC2O4·2H2O], PDF 17-0541). Q (quartz, [SiO₂]), M (mullite, [A16Si2O13]), A (anhydrite, [CaSO4]), P (periclase, [MgO]), L (lime, [CaO]), T (tricalcium aluminate, [Ca3Al2O6]), Hm (hematite, [Fe2O3]), Wh (whewellite, [CaC2O4·H2O]), and H (halite, [NaCl]).

FIGS. 7A-7B show plots indicating the influence of citrate concentration on metal leaching from (FIG. 7A) F-1 and (FIG. 7B) C-1 CFA samples. Leaching condition: 4 h, pH 4, a liquid-to-solid ratio of 200 mL/g, and citrate concentration at 0 (blank), 10, 50, and 100 mM.

FIGS. 8A-8B show plots indicating the evolution of metals remaining in solution as a function of added sodium oxalate. Leaching solutions of (FIG. 8A) and (FIG. 8B) are from F-1 and C-1 CFA samples, respectively. Reaction conditions: pH 4.0, 50 mM citrate, and the liquid-to-solid ratio of 200 mL/g.

FIGS. 9A-9B show plots indicating (FIG. 9A) the enrichment factor of metals in oxalate products as compared to their corresponding concentrations in raw CFA samples F-1 and C-1. (FIG. 9B) Percentage of critical REEs (Nd, Eu, Tb, Dy, Y, and Er) vs. total REEs of raw CFA samples and oxalate products. Gray points in panel (FIG. 9B) are summarized United States (U.S.) CFA samples from Taggart et al. (2016).

FIG. 10 illustrates an overview of the recovery of rare earth elements and other materials from coal fly ash (CFA).

FIGS. 11A-11B show plots indicating the influence of pH (2, 4, and 7) on metal leaching from (FIG. 11A) F-1 and (FIG. 11B) C-1 CFA samples. Leaching condition: 10 mM citrate and the liquid-to-solid ratio of 200 mL/g.

FIGS. 12A-12B show plots indicating the influence of liquid-to-solid ratios (50, 100, and 200 mL/g) on citrate leaching from samples (FIG. 12A) F-1 and (FIG. 12B) C-1. Leaching condition: pH 4 and 50 mM citrate.

FIGS. 13A-13B show SEM images of the metal-oxalate products after oxalate precipitation using the leachate from samples (FIG. 13A) F-1 and (FIG. 13B) C-1.

FIGS. 14A-14B show SEM images of zeolite products after hydrothermal synthesis at 150° C. for samples (FIG. 14A) F-1 and (FIG. 14B) C-1.

FIGS. 15A-15B show XRD patterns of CFA residues and zeolite products for F-1 CFA (FIG. 15A) and C-1 CFA (FIG. 15B) synthesized at 100° C. From top to bottom: (1) CFA residues after metal leaching using citrate, (2) zeolite product after hydrothermal synthesis at 100° C., and (3) zeolite product synthesized at 100° C. by reusing alkaline solution from (2). Vertical gray shadings show the disappearance of quartz and mullite. Red and blue bars are powder diffraction standards: hydroxy-sodalite ([Na_{1.08}Al₂Si_{1.68}O_{7.44}·1.8H₂O], PDF 31-1271), and tobermorite ([Ca₅(OH)₂Si₆O₁₆·4H₂O], PDF 19-1364). Q (quartz, [SiO₂]), M (mullite, [A16Si2O13]), and H (halite, [NaCl]).

FIG. 16 shows an exemplary system diagram for simultaneous waste processing and recovery of rare earth elements according to the present disclosure.

### DETAILED DESCRIPTION

To facilitate an understanding of the principles and features of various embodiments of the present invention, they are explained hereinafter with reference to their implementation in illustrative embodiments.

### Definitions

As used herein, the term coal fly ash (CFA) or fly ash means a fly ash resulting from burning coal. Reference to a specific class of CFA (e.g., Class C or Class F) is intended to refer to the chemical compositions as defined in ASTM C618-12. For example, these classes generally differ in the amount of calcium, silica, alumina, and iron content in the ash. Class F fly ash typically contains less than 20% lime (CaO), while Class C fly ash generally contains greater than 20% CaO. In one embodiment, either Class F or Class C fly ash can be used.

As used herein, the term “zeolite” refers to a family of micro-porous hydrated aluminosilicate minerals. More than 150 zeolite types have been synthesized, and 48 naturally occurring zeolites are known. Zeolites have an “open” structure that can accommodate a wide variety of cations, such as Na⁺, K⁺, Ca²⁺, Mg²⁺ and others. Some exemplary zeolites include Amicite, Analcime, Barrerite, Bellbergite, Bikitaite, Boggsite, Brewsterite, Chabazite, Clinoptilolite, Cowlesite, Dachiardite, Edingtonite, Epistilbite, Erionite, Faujasite, Ferrierite, Garronite, Gismondine, Gmelinite, Gobbinsite, Gonnardite, Goosecreekite, Harmotome, Herschelite, Heulandite, Laumontite, Levyne, Maricopaite, Mazzite, Merlinoite, Mesolite, Montesommaite, Mordenite, Natrolite, Offretite, Paranatrolite, Paulingite, Pentasil, Perlialite, Phillipsite, Pollucite, Scolecite, Sodium Dachiardite, Stellerite, Stilbite, Tetranatrolite, Thomsonite, Tschernichite, Wairakite, Wellsite, Willhendersonite, and Yugawaralite, among others.

As used herein, the term “chelating agent” refers to compounds capable of selectively removing a metal ion, such as a rare earth element, from a material. Exemplary chelating agents include oxalic acid, Ethylenediaminetetraacetic acid (EDTA), diethylenetriaminepentaacetic acid (DTPA), N-(hydroxyethyl)-ethylenediaminetetraacetic acid (HEDTA), nitrilotriacetic acid (NTA), citric acid, and ascorbic acid.

As used herein, the term “precipitation agent” refers to a compound or solution of a compound that is capable of causing a solid REE-containing precipitate to form as the precipitation agent contacts the leachate.

The term “extraction” refers to material removed from a substrate (e.g., a waste ash material) by introducing a solvent. As used herein, the term “leachate” refers to a liquid that has passed through and/or around matter, such as a waste ash source, and has extracted therefrom or otherwise contains soluble or suspended solids or any other component or aspect of the matter to which it was exposed, whether suspended or dissolved.

As used herein, the term “REE-containing waste ash material” and the like is intended to refer to any ash material comprising rare earth elements that were obtained as a waste byproduct. Examples of REE-containing waste ash materials include industrial and municipal solid waste incineration ash and coal fly ash.

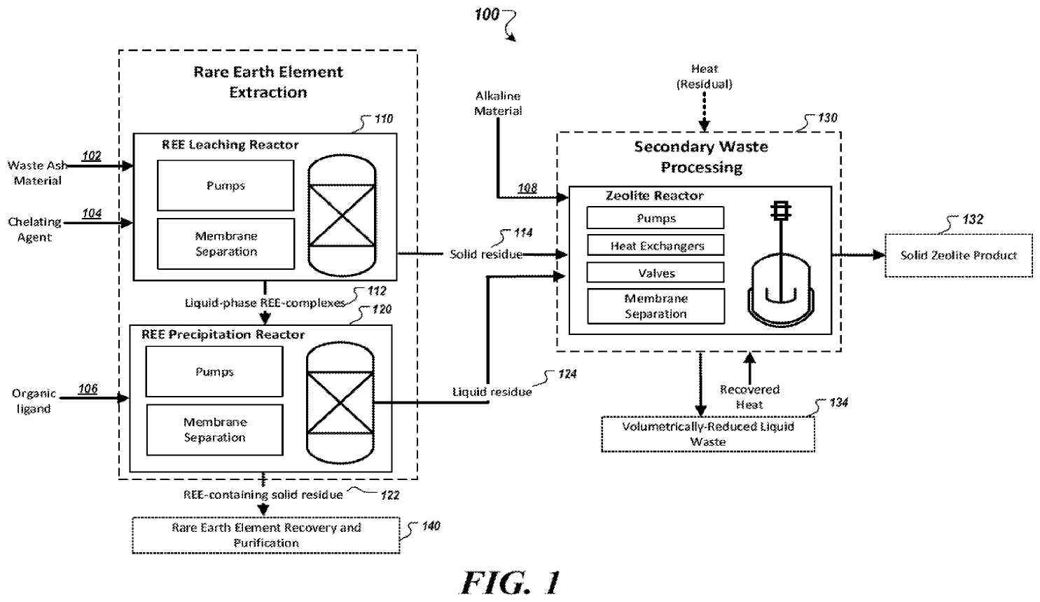

FIG. 1 is a schematic diagram of a system 100 configured to recover rare earth elements and zeolite from an REE-containing waste source. The system 100 includes a first reactor 110 configured to receive an REE-containing waste ash source 102 and a chelating agent 104. In various examples, the first reactor is a continuous stirred-tank reactor. The first reactor 110 is configured to produce a leachate 112 comprising one or more REE and a first residual material 114. The system 100 also includes a second reactor 120 configured to receive the leachate 112 and a precipitation agent 106. The second reactor 120 is configured to produce a second residual material 124 and a solid precipitate 122 comprising an amount of the one or more REE. In various examples, the second reactor is a continuous stirred-tank reactor. In FIG. 1, the solid precipitate 122 is collected for REE recovery and purification 140.

The system 100 shown in FIG. 1, also includes a third reactor 130 configured to receive the first residual material 114 and/or second residual material 124 as well as an alkaline material 108. The third reactor 130 operates under conditions effective to produce a processed waste material comprising zeolites 130 and a volumetrically-reduced liquid waste 134.

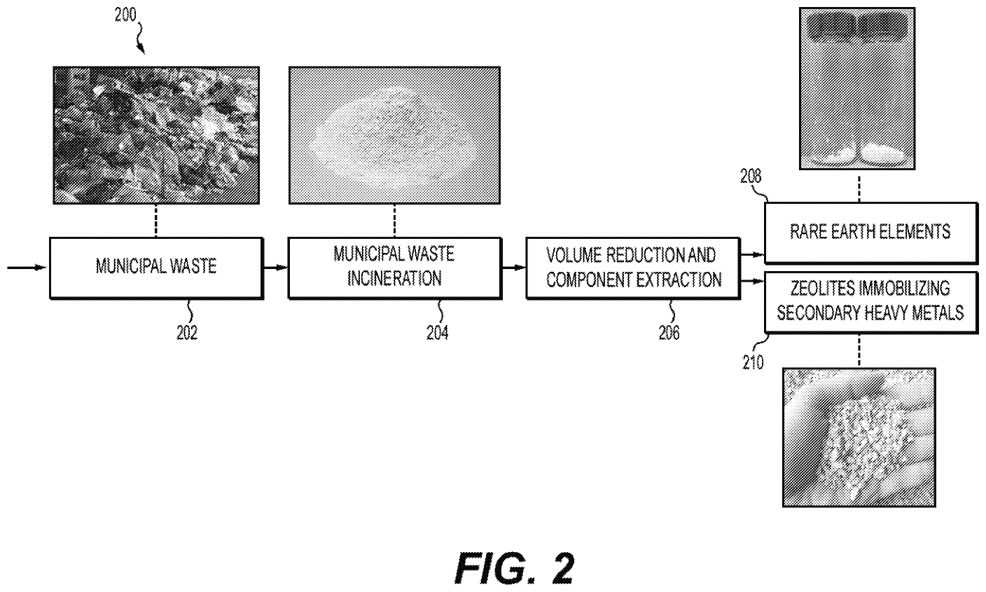

FIG. 2 is a flow diagram of a process 200 for converting municipal waste to commercially usable products. The process 200 includes a municipal waste source 202, which is incinerated to produce municipal waste incineration ash 204. The municipal waste incineration ash 204 is subjected to a step for volumetrically reducing and extracting components 206, including rare earth elements 208 and zeolites immobilizing secondary heavy metals 210.

### Example Systems

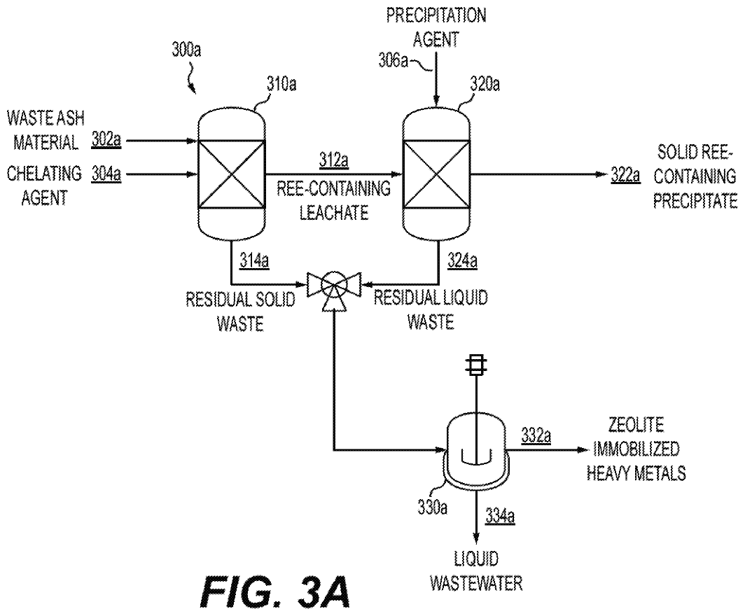

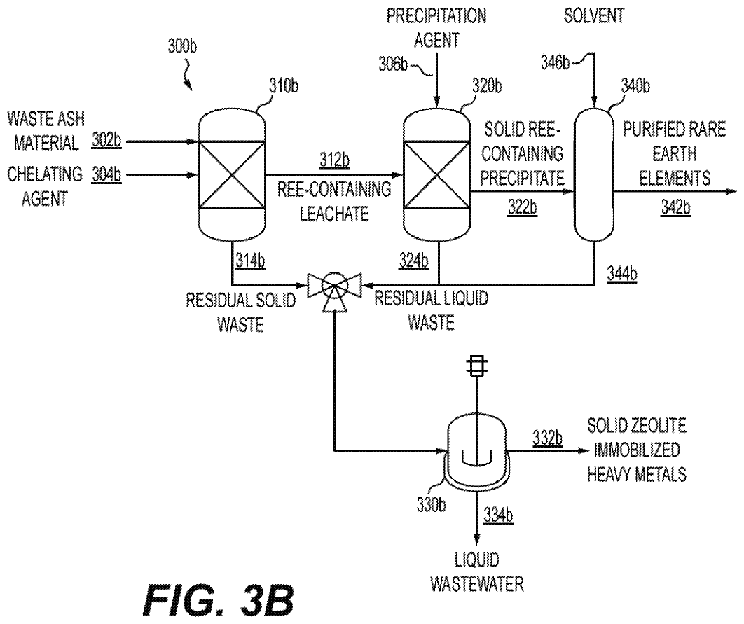

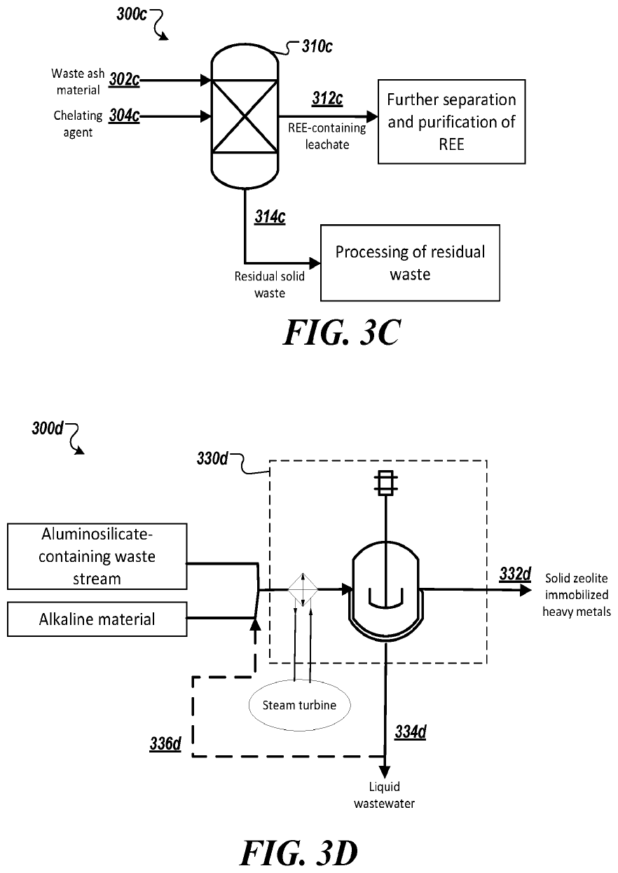

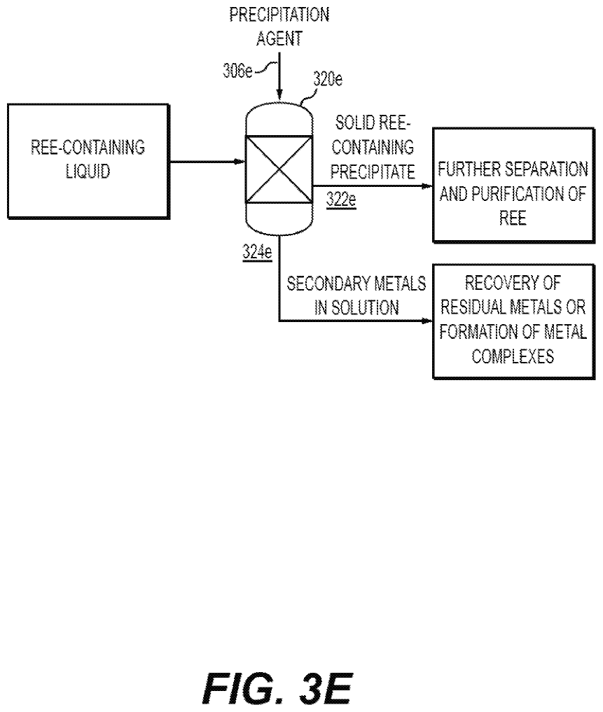

FIGS. 3A-3E each shows schematic diagrams of a system 300 (previously referenced as 100) (shown as 300a, 300b, 300c, 300d) for the recovery of rare earth elements and zeolite from an REE-containing waste source.

In FIG. 3A, the system 300a includes a first reactor 310a configured to receive an REE-containing waste ash source 302a and a chelating agent 304a. In various examples, the first reactor is a continuous stirred-tank reactor. The first reactor 310a is configured to produce a leachate 312a comprising one or more REE and a first residual material 314a. The system 300a also includes a second reactor 320a configured to receive the leachate 312a and a precipitation agent 306a. The second reactor 320a of FIG. 3A is configured to produce a second residual material 324a and a solid precipitate 322a comprising an amount of one or more REE. In various examples, the second reactor is a continuous stirred-tank reactor.

In some embodiments, the REE-containing waste ash source comprises coal fly ash (CFA), municipal solid waste incineration (MSWI) ash, or a combination thereof. In some examples, the REE-containing waste ash source comprises coal fly ash (CFA) (e.g., Class C and/or Class F CFA). In some embodiments, the REE-containing waste ash source comprises 5% or more SiO₂ by weight (e.g., 10 wt % or more SiO₂, 20 wt % or more SiO₂, 30 wt % or more SiO-2, 40 wt % or more SiO₂, 50 wt % or more SiO₂, 60 wt % or more SiO₂, 70 wt % or more SiO₂, or 80 wt % or more SiO₂).

In some embodiments, the first reactor is configured to operate at a pH of 7.0 or less (e.g., 6.0 or less, 5.0 or less, 4.0 or less, 3.0 or less, 2.0 or less, or 1.0 or less).

In some embodiments, the chelating agent comprises an acid (e.g., an organic acid). In some examples, the chelating agent comprises citric acid or a salt thereof (e.g., microbially synthesized citric acid or citrate). In some embodiments, a concentration of citric acid or salt thereof in the first reactor is from 25 mM to 150 mM, such as from 25 mM to 100 mM, from 25 mM to 50 mM, from 50 mM to 100 mM, or about 50 mM.

In some embodiments, the precipitation agent comprises an organic ligand (e.g., oxalic acid or a salt thereof or a microbially synthesized oxalic acid or oxalate). In some embodiments, the solid precipitate comprises an REE-oxalate (e.g., an REE-containing Ca-oxalate).

The system 300a shown in FIG. 3A also includes a third reactor 330a configured to receive the first residual material 314a and/or second residual material 324a as well as an alkaline material 308a. The third reactor 330a operates under conditions effective to produce a processed waste material comprising zeolites 332a and a volumetrically-reduced liquid waste 334a. In some embodiments, the third reactor is configured to operate at a temperature of 50° C. to 300° C. (e.g., from 100° C. to 300° C., 150° C. to 300° C., 200° C. to 300° C., from 50° C. to 250° C., from 50° C. to 200° C., from 100° C. to 200° C., or from 100° C. to 150° C.

As used herein, the term “conditions effective to” refers to conditions to which a material or materials are subjected that result in the formation of a desired zeolite product. Conditions may include temperature, pressure, reaction time, and the like, which are conditions known to those of ordinary skill in the art with the benefit of this disclosure.

Referring to FIG. 3B, the system 300b includes the same components as the system 300a (shown now as 300b), but further includes a separation unit 340b configured to receive the solid precipitate 322b and a solvent 346b, such as a strong acid. As shown in FIG. 3B, the separation unit 346b yields a purified REE-product 342b and a third residual material 344b. The first residual material 314b, second residual material 324b, and/or third residual material 344b can be received by the third reactor 330b under conditions effective to produce a processed waste material comprising zeolites 332b and a volumetrically-reduced liquid waste 334b.

In some embodiments, the separation unit comprises an adsorption column or reactor comprising an adsorbent. The term “adsorption column” refers to a mass transfer device that enables a suitable adsorbent to selectively adsorb a contaminant, i.e., adsorbate, from a fluid containing one or more other contaminants. In some examples, adsorbent comprises functionalized magnetic mesoporous silica particles. Exemplary synthesis schemes of functionalized magnetic mesoporous silica include, for example, those described by Zhao et al. (2014), Zhang et al. (2012), Lin et al. (2009), and Chen et al. (2009), each of which is hereby incorporated by reference in its entirety.

In FIG. 3C, the system 300c includes a first reactor 310c that is configured to receive an REE-containing waste ash source 302c and a chelating agent 304c. The first reactor 310c is configured to produce a leachate 312c comprising one or more REE and a first residual waste 314c. The leachate 312c can be subjected to separation and purification to recover an REE product, while the first residual waste 314c can be further processed to recover additional components (such as zeolites) or reduce its volumetric impact.

Referring now to FIG. 3D, the system 300d includes a reactor 330d configured to receive an aluminosilicate-containing waste stream and an alkaline material. The reactor 330d produces a processed waste material comprising zeolites 332d and a liquid waste stream 334d. A portion of the liquid waste stream 334d can be collected as a recycle stream 336d, where it is contacted with the aluminosilicate-containing waste stream and alkaline material. The system 300d shown in FIG. 3D also includes a steam turbine to provide thermodynamic control of the reactor 330d.

As shown in FIG. 3E, the system 300e includes a reactor 320e configured to receive an REE-containing liquid and a precipitation agent 306e. REE-containing liquid and precipitation agent 306e are contacted in the reactor 320e to form a solid precipitate 322e and a residual stream 324e. The solid precipitate 322e can then be subjected to further separation and purification to yield a purified REE product.

### Example Method #1

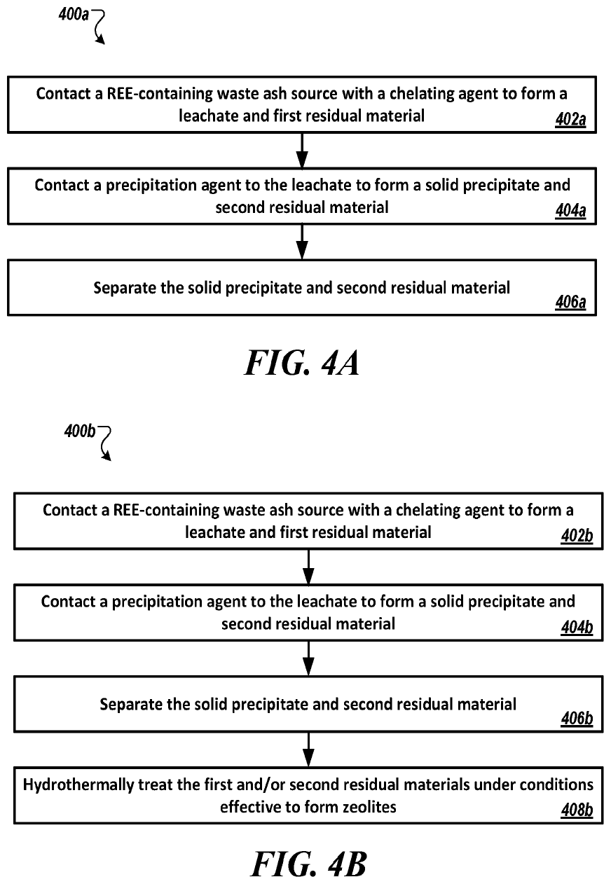

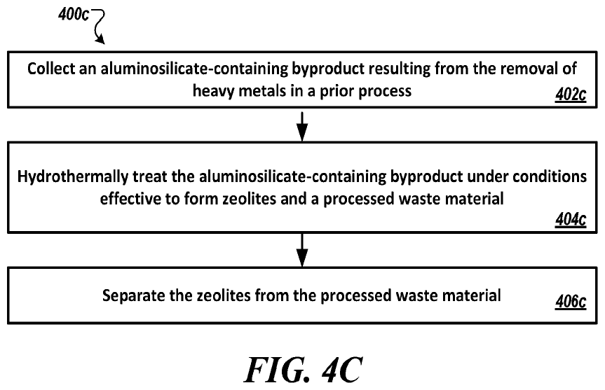

FIGS. 4A and 4B each show a method (400a, 400b) to recover rare earth elements from an REE-containing waste source.

Referring to FIG. 4A, the method (400a) includes contacting (402a) an REE-containing waste ash source (e.g., municipal solid waste incineration ash; coal fly ash) with a chelating agent, thereby forming a leachate comprising one or more REE and a first residual material. As used herein, the term “contacting” refers to the interaction between two or more reagents so that a physical binding reaction or a chemical reaction may take place, e.g., in a reactor and other systems described herein.

In some embodiments, the REE-containing waste ash source comprises coal fly ash (CFA), municipal solid waste incineration (MSWI) ash, industrial solid waste incineration ash, or a combination thereof. In some embodiments, the REE-containing waste ash source comprises coal fly ash (CFA). In various embodiments, the REE-containing waste ash source comprises 5% or more SiO₂ by weight.

In some embodiments, the chelating agent comprises an acid (e.g., an organic acid) or salt thereof. In some embodiments, the chelating agent comprises citric acid or a salt thereof (e.g., microbially synthesized citrate or citric acid). For example, the citric acid or salt thereof can be contacted with the REE-containing waste ash source at a concentration of from 25 mM to 150 mM (e.g., from 25 mM to 100 mM, from 25 mM to 50 mM, from 50 mM to 100 mM, or about 50 mM). In some examples, the REE-containing waste ash source is contacted with the chelating agent at a pH of 7.0 or less (e.g., 6.0 or less, 5.0 or less, 4.0 or less, 3.0 or less, 2.0 or less, or 1.0 or less).

Method 400a further includes contacting (404a) a precipitation agent with the leachate to form a second residual material and a solid precipitate comprising an amount of one or more REE.

In some embodiments, the precipitation agent comprises an organic ligand (e.g., oxalic acid or a salt thereof or a microbially synthesized oxalic acid or oxalate). In embodiments where the precipitation agent includes oxalic acid or a salt thereof, the solid precipitate can comprise an REE-oxalate (e.g., an REE-containing Ca-oxalate).

Method 400a further includes separating (406a) the solid precipitate from the second residual material. This separation of the solid precipitate and the second residual waste can be done using various separation techniques. Exemplary separation techniques include, for example, centrifugation, membrane filtration, and membrane filter pressing (plate and frame filter press with squeezing membranes). In some embodiments, the method can further comprise collecting the separated solid precipitate.

Method 400a can be performed, e.g., in systems (e.g., 100, 300a, 300b, 300d, 300e) described in relation to any one of FIGS. 3A, 3B, 3D, and 3E among others described herein.

### Example Method #2

Referring to FIG. 4B, method 400b performs the operation of steps 402a, 404a, and 406a (shown now as 402b, 404b, 406b).

Method 400b further includes hydrothermally treating (408b) (e.g., using recycled heat or new heat) the first and/or second residual materials under conditions effective to yield a processed material comprising zeolites.

As used herein, the term “conditions effective to” refers to conditions to which a material or materials are subjected that result in the formation of a desired zeolite product. Conditions may include temperature, pressure, reaction time, and the like, which are conditions known to those of ordinary skill in the art with the benefit of this disclosure.

In some embodiments, the method comprises contacting the first residual material with the second residual material prior to or during hydrothermal treatment. In some examples, the first and/or second residual materials are contacted with an alkaline solution prior to or during hydrothermal treatment. In some embodiments, the hydrothermal treating of the first and/or second residual material occurs at a temperature from 50° C. to 300° C.

In some embodiments, zeolites from the processed material are separated to form a zeolite-rich product and a depleted waste material. In some examples, the zeolite-rich product comprises 75% or more zeolites by weight.

Method 400b can be performed, e.g., in systems (e.g., 100, 300a, 300b, 300c, 300d, 300e) described in relation to any one of FIGS. 3A-3E, among others described herein.

### Example Method #3

FIG. 4C shows a method (400c) for processing a residual waste ash material. The method 400c includes collecting (402c) an aluminosilicate-containing byproduct resulting from the removal of heavy metals in a prior process, hydrothermally treating (404c) the aluminosilicate-containing byproduct (e.g., a residual waste ash material comprising a concentration of aluminosilicates) under conditions effective to yield a processed waste ash material comprising zeolites, and substantially separating (406c) the zeolites from the processed waste material, thereby forming a zeolite-rich product and a depleted waste material.

Method 400c can be performed, e.g., in systems (e.g., 100, 300d) described in relation to any one of FIG. 3D, among others described herein.

### DISCUSSION

The exemplary systems and methods can be used to extract rare earth elements (REE) from coal ash or other solid wastes containing high Si contents, such as municipal solid waste incineration ash and industrial solid waste incineration ash. Municipal solid waste incineration can include, for example, ash derived from domestic household waste, sewage sludge, medical or hospital waste, furniture, tires, textiles, plastics, rubber, cartons, and the like. Industrial solid waste incineration can include, for example, ash derived from industrial sludge, paper pulp sludge, wastepaper, waste paperboard, furniture, textiles, plastics, rubber, cartons, and tannery waste.

REE is widely used in a range of high-technology applications. Due to the growing demands of REE and the vulnerability to a potential supply disruption, there has been increasing interest in exploring alternative REE resources and recovery of REE from waste streams. Coal ash has been recently studied as a promising resource for REE recovery. Coal ash is a sizeable industrial waste stream in the U.S., with massive reserves in legacy disposal sites plus ˜40 million tons of newly-produced coal ash every year. The annual value of REE derived from coal ash is estimated to be $4.3 billion. In addition, with stricter governmental regulations, decreasing land space, and increasing costs of coal ash disposal, the management of coal ash poses significant environmental and financial burdens. Thus, recovering REE from coal ash can be employed to address REE scarcity crisis and an opportunity to address the solid waste management problem.

Coal ash is typically a low-grade REE feedstock. The total REE concentration in coal ash generally ranges from 250 to 800 ppm, well below the cutoff grade of 1,000 ppm expressed as rare earth oxide). Previous studies generally focus on REE recovery and utilize highly corrosive acids/bases in combination with high temperatures to leach REEs from coal ash. These leaching processes are chemical- and energy-intensive and are not economically and environmentally viable. Lowering the sintering temperature or using milder mineral acid typically results in significant decreases in REE leaching efficiency.

In addition, leachate from the acid leaching process usually has complex solution chemistry with low REE concentration (e.g., total REEs 30 mg/L) and high concentration of interfering elements (e.g., Na, Al, Ca, and Fe, at 1,000-14,000 mg/L). Multiple techniques have been proposed for downstream REE separation from the leachate, such as solvent extraction, ionic liquid, liquid membrane, and biosorption. Solvent extraction is widely used in REE separation, but working with organic liquids (e.g., kerosene) might be hazardous and unsafe due to harmful, flammable vapors. Efficient REE leaching and separation might be achieved using ionic liquids such as betainium bis(trifluoromethylsulfonyl)imide, but the synthesis of ionic liquids is currently not cost-effective, and the high viscosity of ionic liquids might slow down mass transport in large-scale processes. Organic ligands such as citrate can chelate with REEs and facilitate REE leaching from REE-bearing minerals, coal fine refuse, or coal coarse refuse. Few studies have examined the efficiency of REE leaching from coal ash using organic ligands.

Additionally, REEs or REE-bearing phases only account for a minor fraction of coal ash, and a considerable amount of coal ash solid residues remains after upstream REE leaching. Coal ash solid residues and wastewater production during REE separation necessitate additional treatment steps from a waste management perspective. However, few studies have addressed the fate of secondary wastes after REE leaching and separation.

This method employed an integrated system and method for concurrent REE recovery and waste reduction of coal ash. The system includes, in some embodiments, three modules, which can be implemented alone or in combination with each other or other modules. In module “I,” the module leaches REE from coal ash using sodium citrate. In module “II,” the module separates REE from other trace metals and precipitates as an REE-oxalate product. In module “III,” the module combines the solid residue and wastewater from Modules I and II to synthesize zeolite, a common industrial sorbent, as an additional saleable product. This system and associated method are characterized by the selective recovery of REEs, production of REE-rich products and zeolite, and minimal waste production.

The exemplary systems and methods recover rare earth elements (REE) from coal ash or other solid wastes containing high Si and REE contents, such as municipal solid waste incineration ash. Coal ash and municipal solid waste incineration ash are emerging waste streams that, only until recently, have been studied as promising REE resources. The exemplary method first uses sodium citrate to leach REE from coal ash. The leaching solution is combined with sodium oxalate to precipitate REE and separate from other impurities, such as other trace metals.

These two steps separate REE from other impurities and enrich REE into solid products that can be marketed for downstream processing. Additionally, the produced solid residue and liquid wastewater after REE extraction and precipitation steps are combined to synthesize zeolite, a marketable industrial catalyst, and adsorbent, as an additional product.

Previously published papers and patents utilized highly corrosive mineral acids (e.g., HCl) in combination with high temperatures to leach REE from coal ash (e.g., U.S. Pat. Nos. 8,968,688 and 9,394,586). Such leaching processes are chemical- and energy-intensive and pose environmental and health hazards. In contrast, the exemplary method generally uses organic ligands such as citrate under mild conditions (pH 4-7) and room temperature, which is more environmentally friendly, has a lower energy cost, and is readily scalable.

After REE leaching, previous methods use solvent extraction (e.g., U.S. Pat. No. 8,968,688) or cation exchange (e.g., U.S. Ser. No. 11/186,894) to enrich and separate REE from other impurities. The product is REE-containing solutions. In contrast, the exemplary method may use oxalate to precipitate REE and separate REE from other impurities. The product is an REE-rich solid phase.

Previous methods only focused on REE recovery and only produced REE-containing products. In contrast, the exemplary method may also produce zeolite as a marketable product.

Previous methods produce secondary solid/liquid wastes after REE recovery, which are not treated and cause secondary waste management problems. In contrast, the exemplary method may up-cycle the solid residue and liquid wastewater to synthesize zeolite products, which can minimize the waste volume and eliminate the production of secondary wastes.

The mineral acids used in previous methods for REE extraction cannot be recycled. In the exemplary method, after the zeolite synthesis step, the residual process water may contain citrate and can be reused for REE extraction. Given the growing economic demands of REE and the large annual production of coal ash, the need for recycling REE from coal ash is warranted for both sustainability and environmental considerations.

### Example System Applications

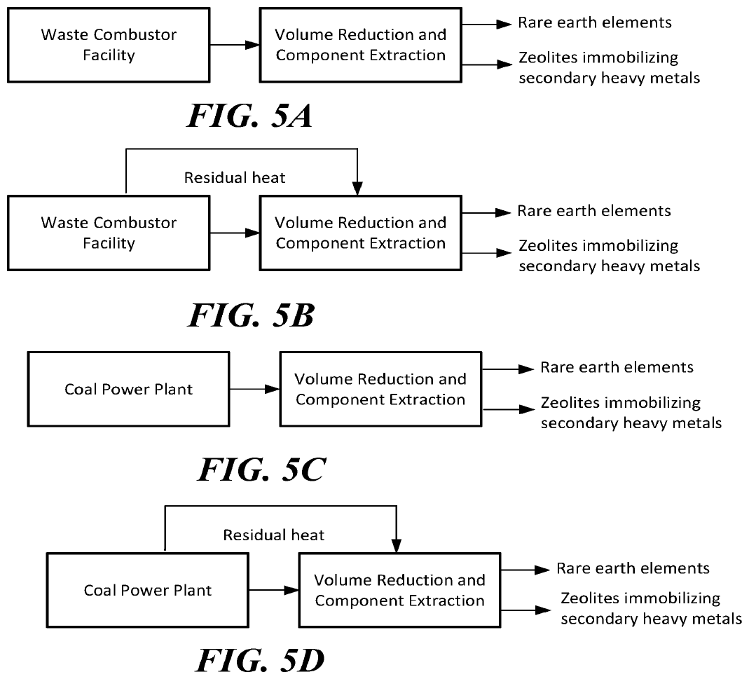

FIGS. 5A-5D each shows various schemes for component extraction and volumetric reduction of different waste ash sources. For example, municipal waste can be incinerated in a waste combustor facility to form solid municipal waste incineration ash as a byproduct, as shown in FIGS. 5A-5B. In FIGS. 5C-5D, coal fly ash is collected as a byproduct from the burning of a coal fuel source in a coal power plant. The solid municipal waste incineration ash and coal fly ash can then be subjected to a volume reduction and component extraction module to produce commercially viable products, including rare earth elements and zeolites. As shown in FIGS. 5B and 5D, residual heat from the combustion of the coal and municipal waste can be recycled to facilitate the volume reduction and component extraction (e.g., zeolite formation). In some examples, the residual heat has a temperature from 50° C. to 300° C., such as from 50° C. to 250° C., from 50° C. to 225° C., from 50° C. to 200° C., from 50° C. to 175° C., from 50° C. to 150° C., from 75° C. to 200° C., from 100° C. to 200° C., from 100° C. to 175° C., or from 100° C. to 150° C. This is beneficial as this heat (e.g., from flue gas) is often not employed in current commercial plants (e.g., coal power plants and waste combustor facilities) and systems and are typically dispelled as waste.

### Experimental Results and Examples

The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference and to the same extent as if each reference was individually incorporated by reference.

Background Rare earth elements (REEs, including lanthanide elements and yttrium) are widely used in a range of high-tech applications [1]. Due to the growing demand of REEs and the vulnerability to a potential supply disruption, the United States (U. S.) has labeled REEs as “critical minerals” [2]. As a result, there has been increasing interest and research to explore alternative REE resources and recovery of REEs from waste streams. For example, the U.S. Department of Energy has initiated programs to examine methods of recovering REEs from coal-related wastes [3], and coal fly ash (CFA) has been proposed as a promising resource for REE recovery [4], [5], [6], [7], [8]. CFA is a sizeable industrial waste stream in the U.S., with massive reserves in legacy disposal sites plus ¬40 million tons of newly-produced CFA every year [9]. The annual value of REEs derived from CFA is estimated to be $4.3 billion [6]. In addition, with stricter government regulations [10] and increasing economic costs on CFA disposal, the management of CFA poses significant environmental and financial burdens. Thus, recovering REEs from CFA is a promising solution to the REE scarcity crisis and an opportunity to address the solid waste management problem.

Although REE-rich CFA was previously identified (e.g., 17,026 ppm [4]), CFA is typically a low-grade REE feedstock. The total REE concentration in CFA generally ranges from 250 to 800 ppm [6], well below the cutoff grade of 1,000 ppm (expressed as rare earth oxide) suggested by Seredin and Dai [4]. Previous studies generally focus on REE recovery and utilized highly corrosive solutions to leach REEs from CFA to yield a high REE leaching efficiency [11], [12], [13], [14], [15], [16]. For example, Taggart et al. (2018) sintered CFA with a 1:1 NaOH-ash ratio at 450° C., followed by leaching with 2 M HNO₃, achieving >70% REEs leached from different types of CFA [11]. Such leaching processes are chemical- and energy-intensive and are not economically and environmentally viable. Lowering the sintering temperature or using milder mineral acid resulted in a significant decrease in REE leaching efficiency [11].

Leachate from the acid leaching process usually has complex solution chemistry with low REE concentration (e.g., total REEs <30 mg/L) and high concentration of interfering elements (e.g., Na, Al, Ca, and Fe, at 1,000-14,000 mg/L) [15]. Multiple techniques have been proposed for downstream REE separation from the leachate, such as solvent extraction [12], [13], ionic liquid [17], [18], liquid membrane [13], and biosorption [19]. Solvent extraction is widely used in REE separation [12], [13], but working with organic liquids (e.g., kerosene) might be hazardous and unsafe due to harmful, flammable vapors [12]. Stoy et al. (2021) achieved efficient REE leaching and separation based on the unique thermomorphic behavior of ionic liquid betainium bis(trifluoromethylsulfonyl)imide with water [17]. However, the synthesis of ionic liquids is currently not cost-effective, and the high viscosity of ionic liquids might slow down mass transport in large-scale processes [18]. As reviewed by Opare et al. (2021), a cost-effective and environmentally friendly approach to REE separation is yet to be achieved [20]; thus, the opportunities remain for exploring alternative separation technologies.

Regarding REE leaching and separation, organic ligands (especially low molecular weight organic acids) might be an environmentally friendly option. A previous study demonstrated that the dominant REE-bearing phases in CFA include REE oxides, REE phosphates (e.g., monazite and xenotime), apatite, etc. [21], [22]. Organic ligands such as citrate can chelate with REEs and facilitate REE leaching from REE-bearing minerals [23]. Yang et al. (2021) tested REE leaching from coal fine refuse using citric acid and suggested that citric acid was not a competitive option compared to mineral acid [24]. In contrast, Ji et al. (2020) examined REE leaching from coal coarse refuse using a set of organic acids, including citric acid, which showed high leaching efficiency comparable to HCl at the same pH [25]. Yet, few studies have examined the efficiency of REE leaching from CFA using organic ligands.

As for REE separation, oxalate is an organic ligand that can be used to precipitate REEs from acidic solutions due to the low solubility of REE oxalate precipitates (e.g., Kₛₚ=10^{-29.2} for La₂(CO)) [26]. Oxalate is typically added at the later stage of REE purification with a relatively high concentration of REEs and a low concentration of interfering ions (e.g., Ca²⁺) Zhang et al. (2020) modeled the interaction of REEs (0.1 mM) with oxalate in the presence of interference ions (e.g., Fe³⁺, Al³⁺, and Ca²⁺ at 0.1-1 mM) at pH 1-5 and showed that REE recovery via REE-oxalate precipitation was thermodynamic favorable [27]. However, results from Zhang et al. (2020) might not be directly applicable to acidic leachate from REE leaching, which has a much lower REE concentration, and experimental results might be different from thermodynamic calculations due to kinetic limitations. The efficacy of selective recovery of REEs from CFA leachate using oxalate requires further investigation.

Additionally, REEs or REE-bearing phases only account for a minor fraction of CFA, and a considerable amount of CFA solid residues remains after upstream REE leaching [15], [21], [28]. CFA solid residues and wastewater production during REE separation necessitate additional treatment steps from a waste management perspective. However, few studies have addressed the fate of secondary wastes after REE leaching and separation. CFA solid residues might be used to recover other valuable metals (e.g., Cu and Zn) [29] or synthesize porous materials (e.g., zeolite) [30], which might minimize waste production and add extra economic benefits.

The goal of this study is to develop an integrated system for concurrent REE recovery and waste reduction of CFA. Specifically, the system disclosed herein includes three modules. In module I, REE leaching from CFA using sodium citrate was investigated. Citrate was selected due to its high chelating ability with REEs. For example, the stability constant of the Y-citrate complex is 10^{9.4}[31].

In module II, REE separation by directly adding oxalate in leachate was examined. Behaviors of other valuable metals (e.g., Cu and Zn) were monitored. To better understand metal speciation and behavior in modules I and II, thermodynamic calculation of aqueous speciation was conducted using PHREEQC [32]. In module III, in order to minimize liquid and solid waste production, the solid residue and wastewater from modules I and II were combined to synthesize zeolite, a common industrial sorbent, as an additional saleable product. Two representative CFA samples, including a Class F (SiO₂+Al₂O₃+Fe₂O₃≥70 wt %) and a Class C (50 wt %≤SiO₂+Al₂O₃+Fe₂O₃≤70 wt %) CFA sample were evaluated. This treatment system is advantageously characterized with the selective recovery of REEs, production of REE-rich products and zeolite, and minimal waste production.

Materials and method—CFA Samples. Class F and a Class C CFA samples were selected for this study, which were collected from coal-fired power plants located in the southeastern U.S. The composition of these two raw samples was well-characterized in earlier studies [21], [28] and are referred to as samples F-1 and C-1, respectively. The major element concentrations were measured using X-ray fluorescence (XRF) [33]. The concentrations of trace metals, including REEs, were measured by inductively coupled plasma mass spectrometry (ICP-MS) after total digestion [21], [22].

Citrate leaching. Unless otherwise specified, chemicals used in this study are all ACS grade or higher. To leach REEs, CFA samples were mixed with sodium citrate under continuous stirring (200 rpm) at room temperature. The solution was maintained at desired pH using dilute HCl and NaOH. Effects of pH (2-7), citrate concentration (50-200 mM), and liquid-to-solid ratio (50-200 mL/g) on REE leaching were examined. After leaching, solids and leachate were separated by vacuum filtration using 0.2 μm filters. Solids were rinsed with deionized water (18.2 MΩ/cm), dried at 45° C., and weighted. The citrate leachate was analyzed for metal concentrations. The leaching efficiency of elements was calculated as:

$$Leaching efficiency ( \% ) \frac{{VC}^{2}}{{MC}_{1}} \times 100 \% \vert \qquad ( 1 )$$

where V (mL) is the volume of the citrate leachate; M (g) is the mass of the CFA sample; C1 and C2 (ppm) are the element concentrations in the CFA sample and citrate leachate, respectively.

Oxalate precipitation. To separate REEs from citrate leachate after leaching, sodium oxalate was gradually added. After each addition, the reaction was allowed to proceed for 30 min under stirring (200 rpm) at room temperature. Solution aliquots were collected for concentration analysis. Metals that remained in the leachate after oxalate addition was calculated as:

$$Metal remained ( \% ) \frac{{C}^{*}}{{C}_{0}} \times 100 \% \qquad ( 2 )$$

where C₀ and C* (ppm) are the concentration of metals in the initial citrate leachate and after oxalate addition, respectively.

Oxalate precipitates were harvested at the end of the experiment, rinsed, and dried at 45° C. The element concentration of the oxalate precipitates was measured by ICP-MS after acid digestion. The enrichment factor of elements in oxalate products as compared to raw CFA samples was calculated as:

$$Enrichment factor = \frac{{C}_{oxalate \_ product}}{{C}_{CFA}} \qquad ( 3 )$$

where C_{CFA} and C_{oxalate_product} (ppm) are element concentrations in the raw CFA sample and oxalate products, respectively.

Thermodynamic modeling. To better understand element speciation in citrate leachate and element behavior during oxalate precipitation, thermodynamic calculations of aqueous speciation were conducted using the program PHREEQC [32]. The minteq.v4.dat database was used. The stability constants of REE-ligand complexes (e.g., Cl⁻, CO₃²⁻, citrate, oxalate, etc.) and solubility products of relevant REE mineral phases were compiled from the literature [31], [34]-[41]. Citrate solution containing major elements (Na, Mg, Ca, and Al, ranging from 10 to 1000 mg kg−1 water) and trace metals (Cr, Co, Ni, and REEs, ranging from 1 to 1000 μg kg⁻¹ water) was included in the solution phase to simulate the composition of the citrate leachate from samples F-1 and C-1. Details of the considered metal-ligand interactions and leachate chemistry are summarized in Table 1.

TABLE 1
Summary of leachate chemistry for PHREEQC modeling. All elements
listed here were considered in the presence of citrate (module
I). For modeling metal behavior in the presence of oxalate
(module II), only species with * were considered, of which
metal-oxalate stability constants were available.

Chemistry

| | Leachate from | Leachate from |
|---|---|---|
| | sample F-1 | sample C-1 |
| pH | 4.0 | 4.0 |
| Temperature (° C.) | 25 | 25 |
| CO₃²⁻ (mg/kgw)* | 10 | 20 |
| Cl⁻ (mg/kgw)* | 500 | 500 |
| SO₄²⁻ (mg/kgw)* | 50 | 100 |
| Citrate (mmol/kgw)* | 50 | 50 |
| Oxalate (mmol/kgw)* | 0-3 | 0-5 |
| Na⁺ (mg/kgw)* | 500 | 500 |
| Mg²⁺ (mg/kgw)* | 50 | 300 |
| Al³⁺ (mg/kgw) | 50 | 200 |
| K⁺ (mg/kgw)* | 100 | 100 |
| Ca²⁺ (mg/kgw)* | 200 | 1000 |
| Fe³⁺ (mg/kgw) | 250 | 100 |
| Co²⁺ (ug/kgw) | 15 | 100 |
| Ni²⁺ (ug/kgw) | 40 | 200 |
| Cu²⁺ (ug/kgw)* | 400 | 1000 |
| Zn²⁺ (ug/kgw)* | 150 | 400 |
| Sr²⁺ (mg/kgw) | 10 | 100 |
| La³⁺ (ug/kgw)* | 25 | 200 |
| Ce³⁺ (ug/kgw)* | 50 | 350 |
| Pr³⁺ (ug/kgw) | 6 | 50 |
| Nd³⁺ (ug/kgw)* | 30 | 170 |
| Sm³⁺ (ug/kgw)* | 6 | 36 |
| Eu³⁺ (ug/kgw)* | 2 | 10 |
| Gd³⁺ (ug/kgw)* | 8 | 35 |
| Tb³⁺ (ug/kgw) | 1 | 5 |
| Dy³⁺ (ug/kgw)* | 6 | 30 |
| Y³⁺ (ug/kgw)* | 30 | 180 |
| Ho³⁺ (ug/kgw) | 1 | 5 |
| Er³⁺ (ug/kgw)* | 3 | 20 |
| Tm³⁺ (ug/kgw) | 1 | 3 |
| Yb³⁺ (ug/kgw)* | 3 | 15 |
| Lu³⁺ (ug/kgw) | 1 | 2 |

Zeolite synthesis. To reduce the production of secondary residues, zeolite was synthesized in hydrothermal reactors (Parr Instrument) using the solid residues and wastewater after REE separation. 0.2 g CFA solid residues from the citrate leaching step were mixed with 10 mL wastewater from the oxalate precipitation step. 5 M NaOH was used as an activation agent. The hydrothermal reactors were sealed and heated at 100 or 150° C. under autogenous pressure for 24 h. The synthesized solids were collected by vacuum filtration, rinsed, and dried at 45° C. for composition, structure, and morphology analysis.

Analytical methods—Inductively coupled plasma mass spectrometry (ICP-MS). Element concentration in the solution during citrate leaching and oxalate precipitation was measured using ICP-MS (Agilent 7500a). All solution aliquots were diluted with HNO₃ solution and spiked with 10 ppb of indium (In) as an internal standard to monitor instrument drift. A series of calibration standards (0-200 ppb) was prepared using standards from SPEX (CertiPrep) and Sigma-Aldrich (TraceCert). Each calibration standard was spiked with 10 ppb In. The mass spectrometer was tuned for high sensitivity, low isobaric interference (CeO⁺/Ce⁺<1%), and low doubly charged ions (<2%). ⁵³Cr, ⁵⁹Co, ⁶⁰Ni, ⁶³Cu, ⁶⁶Zn, ⁷²Y, ¹³⁹La, ¹⁴⁰Ce, ¹⁴¹Pr, ¹⁴⁶Nd, ¹⁴⁷Sm, ¹⁵³Eu, ¹⁵⁷Gd, ¹⁵⁹Tb, ¹⁶³Dy, ¹⁶⁵Ho, ¹⁶⁶Er, ¹⁶⁹Tm, ¹⁷²Yb, and ¹⁷⁵Lu were measured. Calibration standards were measured after every 20 samples to ensure accuracy.

X-ray diffraction (XRD). CFA samples and solid products were analyzed using a Panalytical Empyrean multipurpose diffractometer with Cu Ku radiation and a PIXcel 3D-Medipi×3 1×1 detector. XRD patterns were recorded over 5-50° 2θ with a step size of 0.03° 2θ and a contact time of 15 s/step at 45 kV and 40 mA.

Scanning electron microscopy and energy-dispersive X-ray spectroscopy (SEM-EDX). The morphology of CFA samples, oxalate products, and zeolite products was examined using Hitachi SU8230. Samples were gently ground before being dusted onto carbon tape. SEM images were taken at 5 kV and 10 ρA with a working distance of 5 mm. EDX spectra were obtained at 15 kV and 30 ρA with a working distance of 15 mm using an Oxford X-MaxN EDX detector.

### Results and Discussion

CFA samples. The chemical composition of samples F-1 and C-1 is summarized in Table 2. Sample F-1 is enriched in SiO₂ (54.3%), Al₂O₃ (25.2%), and Fe₂O₃ (11.9%), while sample C-1 is relatively abundant in CaO (28.1%). The total REE content in sample F-1 is similar to that of sample C-1 (˜315 ppm). Among all REEs, Ce shows the highest concentration at ˜110 ppm. The total concentrations of light REEs (LREEs, from La to Sm) and heavy REEs (HREEs, from Eu to Lu plus Y)¹ in both samples are around 230 ppm and 80 ppm, respectively. Notably, the fraction of critical REEs (Nd, Eu, Tb, Dy, Y, and Er) [4] in total REEs for sample F-1 (35.5%) is slightly higher than that of sample C-1 (32.1%). The concentrations of other trace metals (e.g., Cr, Cu, and Zn) range from 20 to 200 ppm. Sample F-1 contains more Cr, Co, Ni, and Zn as compared to sample C-1, except for Cu.

TABLE 2
Chemical composition of raw CFA samples and oxalate products.

| | Sample | | | |
|---|---|---|---|---|
| | F-1 | | C-1 | |
| | | Oxalate | | Oxalate |
| | Raw CFA | product | Raw CFA | product |
| Coal basin | Illinois | — | Powder | — |
| | Basin | | River Basin | |
| Coal type | bitu- | — | subbitu- | — |
| | minous | | minous | |
| Coal fly | Class F | — | Class C | — |
| ash type | | | | |
| SiO₂ (wt %)^{a} | 54.3 | 0.0 | 36.6 | 0.0 |
| Al₂O₃ | 25.2 | 1.6 | 18.2 | 0.8 |
| (wt %) | | | | |
| Fe₂O₃ | 11.9 | 0.0 | 6.4 | 0.0 |
| (wt %) | | | | |
| CaO (wt %) | 1.6 | 93.0 | 28.1 | 95.7 |
| Other | 7.0 | 5.4 | 10.7 | 3.5 |
| (wt %) | | | | |
| Cr (ppm)^{b} | 174.6 ± 3.0 | 60.8 ± 1.8 | 85.9 ± 9.9 | 2.7 ± 0.1 |
| Co (ppm) | 45.1 ± 7.8 | 0.8 ± 0.0 | 23.1 ± 0.0 | 5.2 ± 0.7 |
| Ni (ppm) | 116.8 ± 6.2 | 0.5 ± 0.0 | 57.0 ± 3.5 | 10.8 ± 0.9 |
| Cu (ppm) | 128.3 ± 5.1 | 79.5 ± 9.3 | 183.5 ± 8.0 | 79.6 ± 4.6 |
| Zn (ppm) | 169.9 ± 12.6 | 22.8 ± 0.5 | 109.4 ± 4.5 | 3.4 ± 0.0 |
| La (ppm) | 49.2 ± 0.8 | 208.6 ± 35.4 | 57.6 ± 0.43 | 121.0 ± 13.2 |
| Ce (ppm) | 102.2 ± 6.8 | 405.1 ± 38.6 | 111.0 ± 1.6 | 235.0 ± 21.1 |
| Nd (ppm) | 49.3 ± 0.2 | 205.9 ± 31.1 | 49.5 ± 0.3 | 104.3 ± 12.2 |
| Eu (ppm) | 2.1 ± 0.1 | 9.1 ± 0.8 | 3.0 ± 0.2 | 5.9 ± 0.8 |
| Y (ppm) | 52.8 ± 2.6 | 199.1 ± 30.8 | 44.1 ± 1.6 | 90.5 ± 13.4 |
| LREEs | 224.0 ± 11.1 | 917.5 ± 121.8 | 241.3 ± 2.3 | 508.7 ± 51.5 |
| (ppm) | | | | |
| HREEs | 91.4 ± 5.9 | 364.7 ± 54.2 | 78.5 ± 1.2 | 156.1 ± 25.0 |
| (ppm) | | | | |
| Critical | 111.8 ± 5.9 | 488.6 ± 74.2 | 102.7 ± 1.2 | 228.1 ± 31.2 |
| REEs (ppm) | | | | |
| Total | 315.4 ± 9.9 | 1282.2 ± 176.0 | 319.8 ± 2.1 | 664.9 ± 76.6 |
| REEs (ppm) | | | | |
| Critical | 35.5 ± 0.0 | 38.1 ± 0.6 | 32.1 ± 0.1 | 34.3 ± 0.7 |
| REEs (%) | | | | |

^{a}Major element information measured by XRF or EDX.
^{b}Concentration of trace metal elements in raw coal fly ash is from Liu et al. (2019) and Liu et al. (2020).

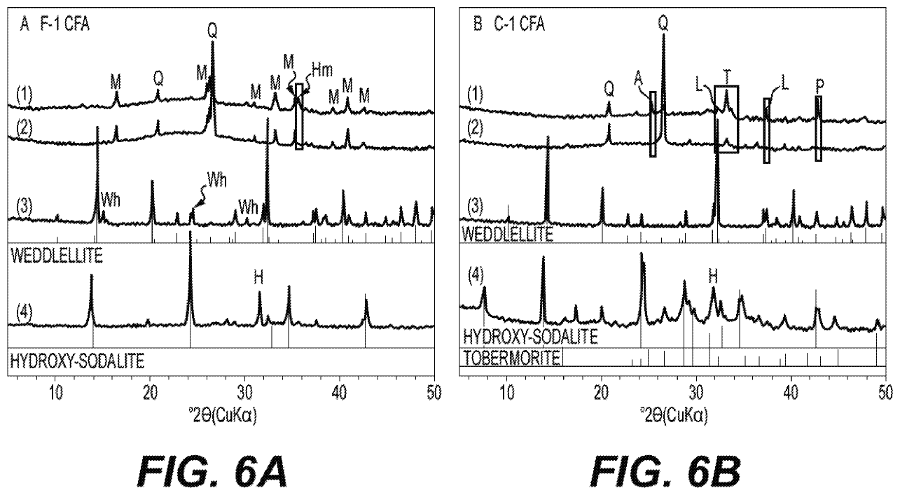

XRD patterns of the CFA samples are shown in FIGS. 6A-6B. Quartz [SiO₂], mullite [Al₆Si₂O₁₃], and hematite [Fe₂O₃] are the main mineral phases identified in sample F-1. Sample C-1 shows a complex mineralogical composition, including quartz, anhydrite [CaSO₄], tricalcium aluminate [Ca₃Al₂O₆], lime [CaO], and periclase [MgO]. Notably, a broad hump at 20-30° 2θ suggests the presence of amorphous aluminosilicate glass in CFA samples, which is a major component (50-80 wt %) in CFA⁴². Under SEM, most CFA particles are spherical with a particle size of 1-100 μm.

Citrate leaching. The leaching kinetics were first investigated using 50 mM citrate at pH 4 and a liquid-to-solid ratio of 200 mL/g. All metals of interest in samples F-1 and C-1 reached a steady state after 3 h and ˜4 h, respectively. Based on this data, the following leaching experiments were conducted for 4 h.

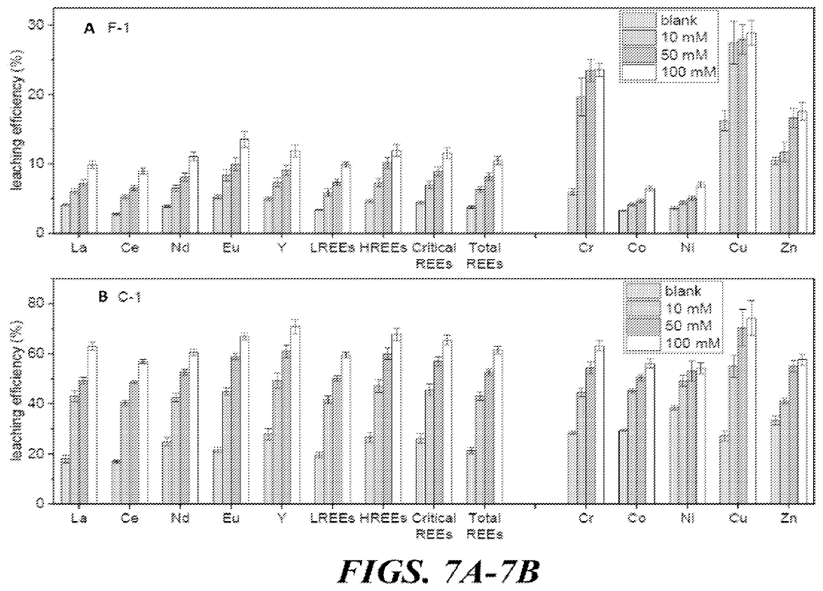

To examine the effect of citrate concentration on metal leaching from CFA samples, citrate concentration was varied (0-100 mM), while the pH and liquid-to-solid ratio were fixed at 4 and 200 mL/g, respectively. In the absence of citrate, only ˜5% of REEs are leached from sample F-1, while sample C-1 is characterized by higher REE leaching efficiency at ˜20% (FIGS. 7A-7B). Previous studies have also shown a higher REE leaching efficiency of Class C than Class F CFA using HNO₃ or HCl [6], [21]. Similar behavior was also observed for other trace metals, such as Cr, Co, and Ni [28]. However, the metal leaching efficiency of both CFA samples is low or middling at pH 4.

In the presence of citrate, metal leaching from both CFA samples is remarkably enhanced (FIGS. 7A-7B). When citrate concentration increases from 0 to 50 mM, REE leaching efficiency increases from 5% to 10% for sample F-1 and from ˜20% to ˜60% for sample C-1. Leaching efficiency of other trace metals is also improved in the presence of citrate. Thermodynamic speciation calculation using PHREEQC shows that metal-citrate complexes are the main species of all REEs (˜100%) and other trace metals (>90% for Co, Ni, and Cu).

Solid residues of the CFA samples after citrate leaching were characterized by SEM and XRD. Although SEM did not observe noticeable morphology changes, XRD analysis shows mineral dissolution after metal leaching (FIGS. 6A-6B). After citrate leaching, hematite was completely dissolved in sample F-1, whereas anhydrite, lime, periclase, and most of the tricalcium aluminate were dissolved in sample C-1. The formation of metal-citrate complexes and dissolution of solid phases might explain the increasing leaching efficiency in the presence of citrate.

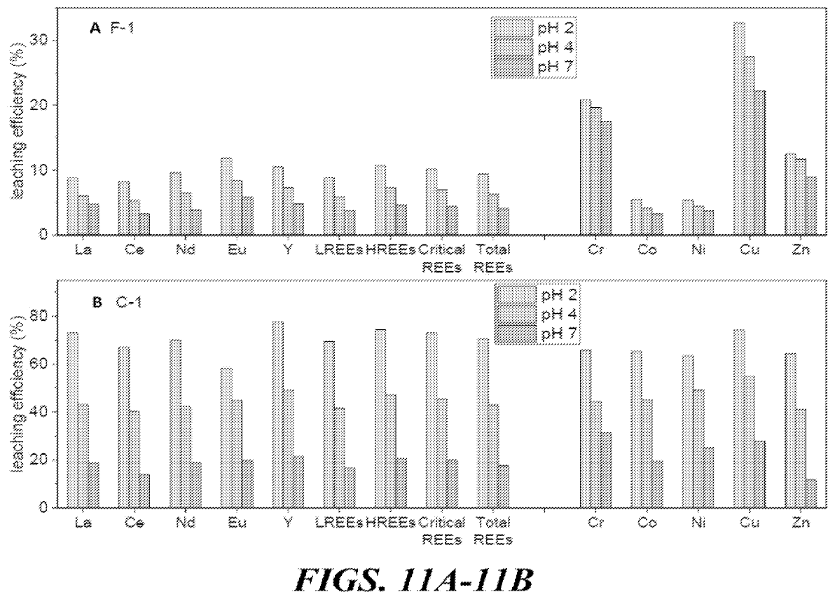

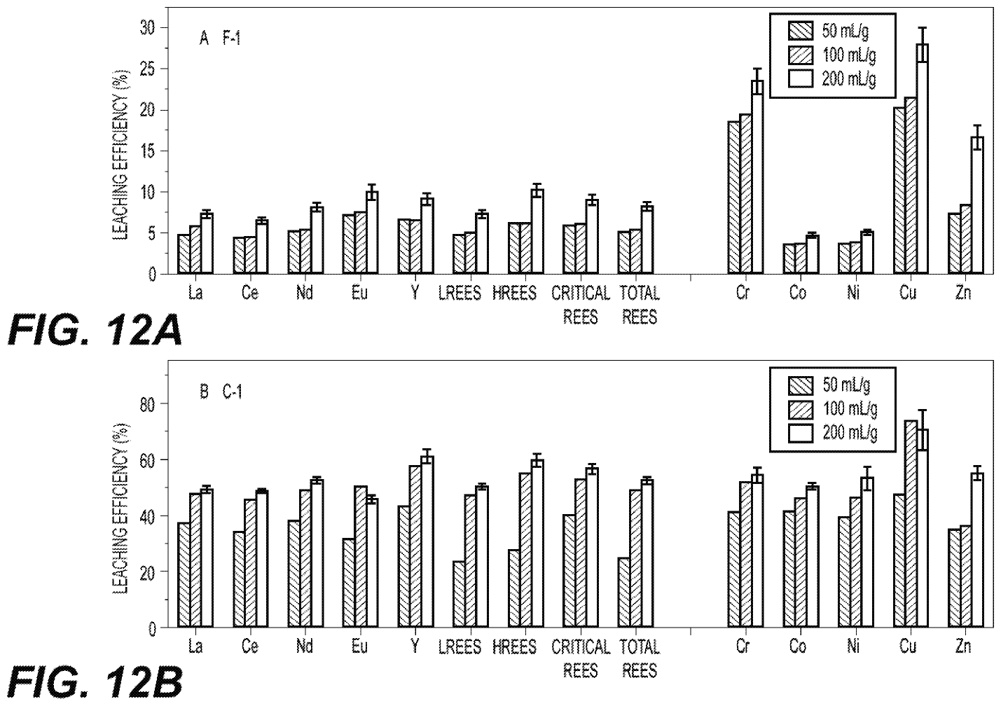

Further increasing citrate concentration from 50 to 100 mM does not lead to a notable increase in metal leaching efficiency, likely reaching a maximal leaching efficiency at pH 4 (FIGS. 7A-7B). The influence of pH and liquid-to-solid ratio on leaching efficiency was explored (FIGS. 11A-11B and 12A-12B) and discussed further below.

Effect of pH. The effect of pH on citrate leaching was investigated with 10 mM citrate and a liquid-to-solid ratio of 200 mL/g. REE leaching efficiency increases significantly as pH decreases (FIGS. 11A-11B): for sample F-1, REE leaching efficiency increases from ˜5% to 10% as pH decreases from 7 to 2; while sample C-1 is characterized with a more evident increase from 20% at pH 7 to 75% at pH 2. As for other metals of interest, sample C-1 displays a consistent increase from ˜20% to ˜70% for Cr, Co, Ni, Cu, and Zn. On the other hand, Cr, Cu, and Zn in sample F-1 show an intermediate leaching efficiency of 10-20% even at pH 7 and a further increase by ˜5% as pH decreases to 2, while Co and Ni in sample F-1 display a low leaching efficiency at 5% and barely increase with decreasing pH.

Effect of liquid-to-solid ratio. To explore the influence of liquid-to-solid ratio on metal leaching efficiency, pH and citrate concentration were fixed at 4.0 and 50 mM, respectively (FIGS. 12A-12B). For sample F-1, increasing the liquid-to-solid ratio from 50 to 100 mL/g does not result in a significant change in metal leaching efficiency, and further increasing the liquid-to-solid ratio to 200 mL/g only leads to 5-10% increase in leaching efficiency. In contrast, sample C-1 shows a significant increase of 10-20% in leaching efficiency for all metals as the liquid-to-solid ratio increases from 50 to 100 mL/g; but further increasing of the liquid-to-solid ratio to 200 mL/g does not result in a significant change.

Oxalate precipitation. Following citrate leaching (module I), the study conducted an oxalate precipitation step (Module II) to separate REEs from the dilute citrate leachate. Citrate leachate was collected from experiments with 50 mM citrate at pH 4 and a liquid-to-solid ratio of 200 mL/g. The study selected this reaction condition for the oxalate precipitation experiment because metal leaching efficiency is relatively high for both CFA samples at this condition and the leachate pH is not too low.

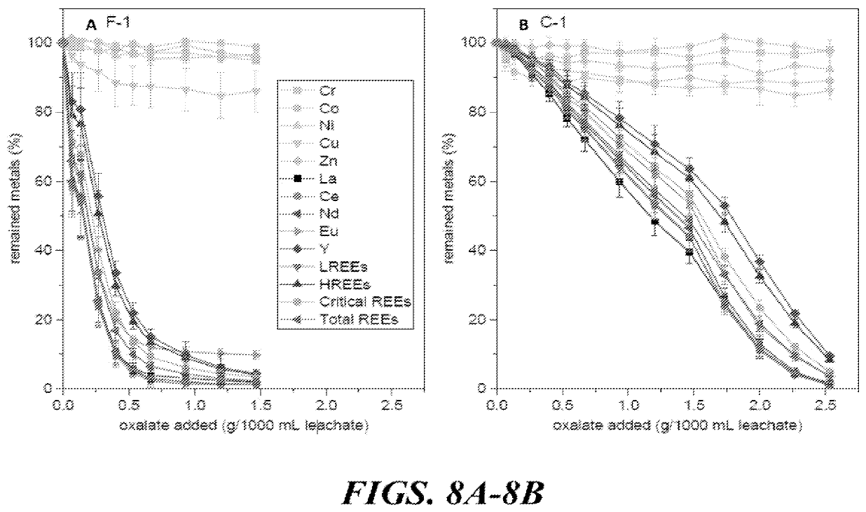

Precipitates gradually formed in the citrate leachate upon the addition of oxalate. The fraction of metals remaining in the solution as a function of added oxalate concentration is plotted in FIGS. 8A-8B. The concentration of dissolved REEs sharply decreased with the addition of oxalate and the formation of the solid precipitates, while other metals (Cr, Co, Ni, Cu, and Zn) remained in the solution with only up to ˜10% removal (Cu). In addition, LREEs are preferentially removed into the solid precipitates as compared to HREEs. Additionally, the decrease of REE concentration for sample F-1 is significantly faster than that of sample C-1. As a result, only ˜1.5 g oxalate (per 1000 mL leachate) is needed to precipitate >95% REEs from the citrate leachate of sample F-1, but ˜2.5 g oxalate is required for sample C-1 (FIGS. 8A-8B). During the whole process, the solution pH slightly increases from 4.0 to 4.15.

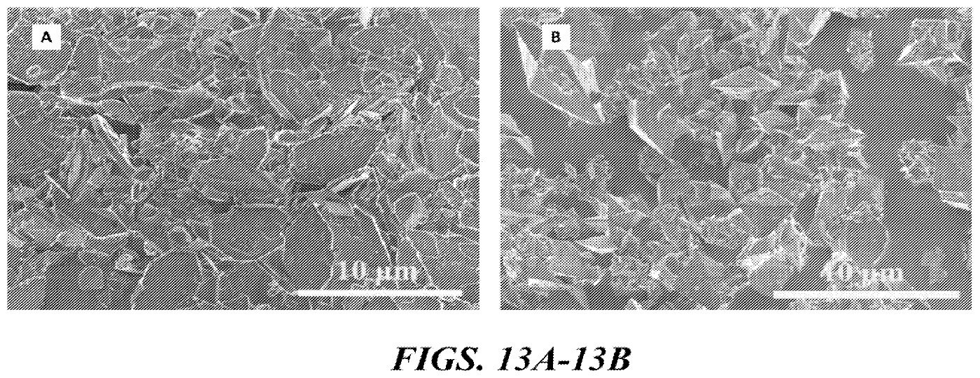

XRD analysis of the solid precipitates (FIGS. 6A-6B) identified the solids to be primarily weddellite [CaC₂O₄ 2H₂O]. For the precipitates from sample F-1, there is also a small amount of whewellite [CaC₂O₄·H₂O]. Under SEM (FIGS. 13A-13B), weddellite particles are easily recognized because of the distinctive bi-pyramid shape, which corresponds to the (101) facets of the tetragonal structure; whewellite particles, on the other hand, have a plate-like shape, corresponding to the (100) facets [43], [44], [45].

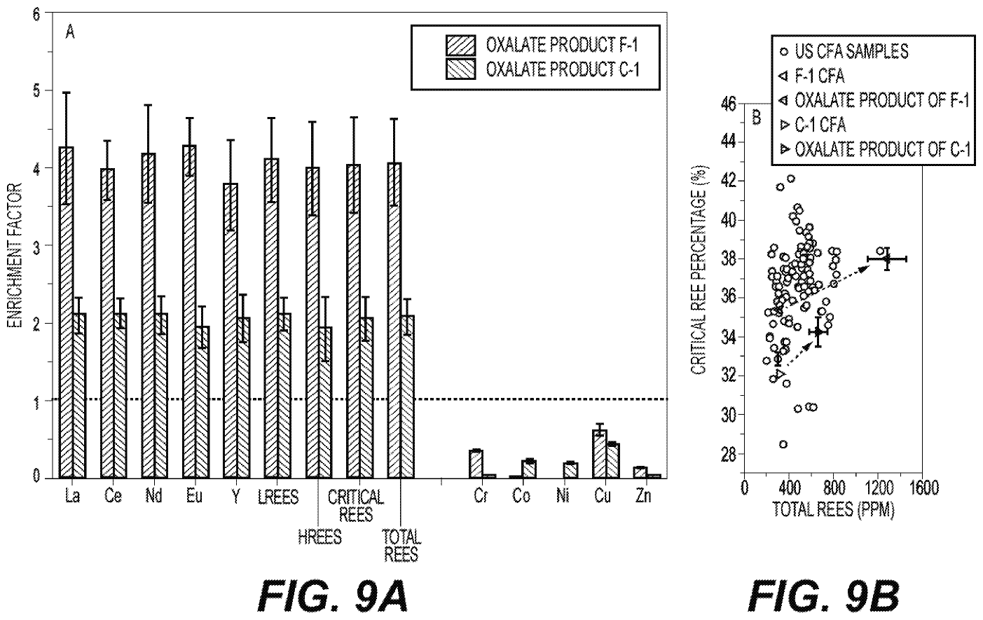

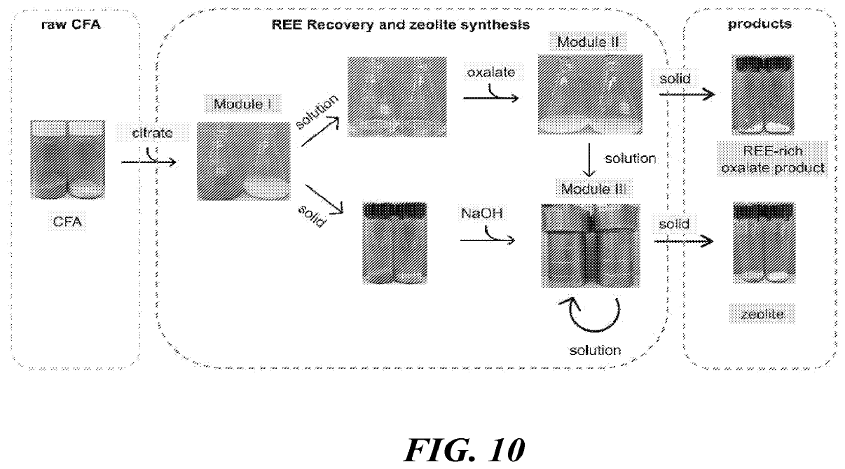

Metal concentrations in the oxalate precipitates are summarized in Table 2, and the enrichment factors of those metals are plotted in FIGS. 9A-9B. The oxalate precipitates are depleted in Cr, Co, Ni, Cu, and Zn as compared to the raw CFA samples (i.e., enrichment factor <1). In marked contrast, REEs are substantially enriched in the oxalate precipitates. The total REE concentration in the oxalate precipitates from sample F-1 is close to 1300 ppm, which is 4-fold higher than the raw F-1 CFA sample. For the precipitates from sample C-1, this value is about 650 ppm, 2-fold higher than the raw C-1 CFA sample. Such enrichment factors are higher than or comparable to that of physical enrichment methods (e.g., 2.14 for density separation [46]), combined physical separation and hydrothermal enrichment methods at 2.7 [47], solvent extraction at 2.6 and liquid membrane at 2.4-7.5 (calculated based on results in Smith et al. [13]). EDX spectra show the predominance of CaO (>93 wt %) in the oxalate products (Table 2). REEs are not detected in the oxalate products, probably because the concentration of individual REEs is still below the EDX detection limit (˜0.1 wt %). The percentage of critical REEs in total REEs for the raw CFA samples and the REE-rich oxalate precipitates are plotted in FIG. 9B and compared to U.S.-based CFA samples [6]. Most U.S.-based CFA samples contain 32-38% critical REEs, and the total REE concentration ranges from 250 ppm to 800 ppm. After metal leaching using citrate and metal precipitation using oxalate, data points greatly shift towards the upper-right corner, suggesting that the REE-rich oxalate precipitates are more promising for downstream REE recovery.

Thermodynamic calculations were conducted to obtain a better understanding of the metal selectivity in the presence of oxalate. Calcium oxalate is the only phase oversaturated with the addition of oxalate (i.e., saturation index, SI>1). In contrast, the precipitation of REE-oxalate and other metal (e.g., Mg, Sr, Cu, and Zn) oxalate phases are not thermodynamically favorable (i.e., SI<1). However, the decrease of Ca concentration in F-1 and C-1 leachate showed a similar trend as the decreases of REEs (FIGS. 8A-8B). Such consistency might suggest the incorporation or coprecipitation of REEs during the formation of calcium oxalate. Zhang et al. (2020) modeled REE behaviors in the presence of oxalate and interfering elements. They suggested that REE recovery via REE-oxalate precipitates was feasible, and the presence of Ca²⁺ had a negligible effect on REE recovery at pH 1-5 [27]. However, results from this study show that the formation of pure REE oxalates might be hindered due to the coprecipitation of Ca and REEs.

Zeolite synthesis. Zeolite is a group of crystalline aluminosilicate minerals that has a three-dimensional framework of Si/Al tetrahedrons with lots of voids and open spaces. Additionally, the substitution of Si(V) by Al(III) results in permanent negative changes in zeolite and, consequently, a high cation exchange capacity (CEC) of zeolite [48]. Because of those unique properties, zeolite has a wide range of industrial applications (e.g., waste absorbent and molecule sieve) [49]. Hydrothermal synthesis of zeolite from CFA has been extensively studied. Up to 15 types of zeolite (e.g., zeolite NaP1, A, and X) can be synthesized from CFA depending on CFA chemical composition (e.g., SiO₂/Al₂O₃ ratio), temperature (e.g., 80-200° C.), alkaline solution concentration (e.g., 0.5-5 M NaOH), liquid-to-solid ratio (1-50 mL/g), and reaction time (3-48 h) [48], [49].

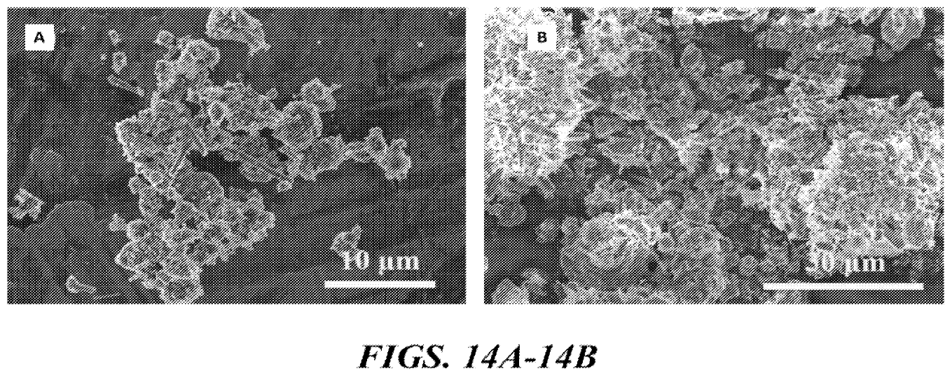

To demonstrate that CFA solid residues after citrate leaching can be used for zeolite synthesis, the solid residues after module I (citrate leaching) were reacted with the waste leachate after module II and 5 M NaOH at 100 or 150° C. At 100° C., reflection peaks of quartz and mullite decrease significantly, and the broad hump at 20-30° 2θ is flattened, suggesting the disappearance of amorphous aluminosilicates. On the other hand, new reflections of hydroxy-sodalite [Na_{1.08}Al₂S_{11.68}O_{7.44}·1.8H₂O] and halite [NaCl] appeared in both samples. The presence of halite in samples might be due to insufficient rinse of the products. At 150° C., quartz and mullite completely disappeared, and more hydroxy-sodalite formed in both products (FIGS. 6A-6B). For sample C-1, tobermorite [Ca₅(OH)₂Si₆O₁₆·4H₂O], a Ca-type zeolite, formed as well, likely due to the higher Ca content in C-1. Both hydroxy-sodalite and tobermorite are common types of zeolite that can be synthesized from CFA, especially with high concentrations of NaOH [48.] The synthesized zeolite particles form aggregates as observed by SEM (FIGS. 14A-14B), which are distinctly different from the spherical morphology of CFA particles. Among zeolite particles, some rob-like particles (˜10 μm) are observed in both samples, which might be halite (FIGS. 14A-14B). The CEC of sodalite synthesized from CFA generally ranges from 250 meq/100 g to 350 meg/100 g [50], ideal for applications such as catalyst, wastewater treatment, or soil amendment [48].

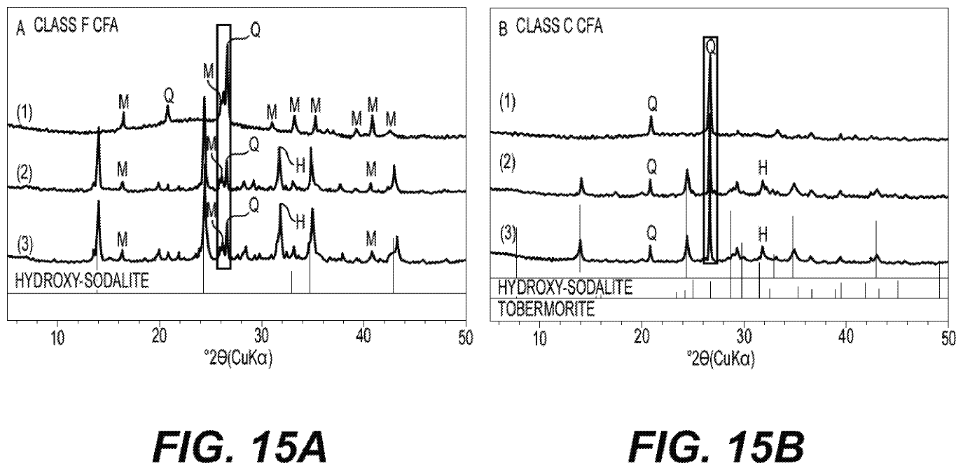

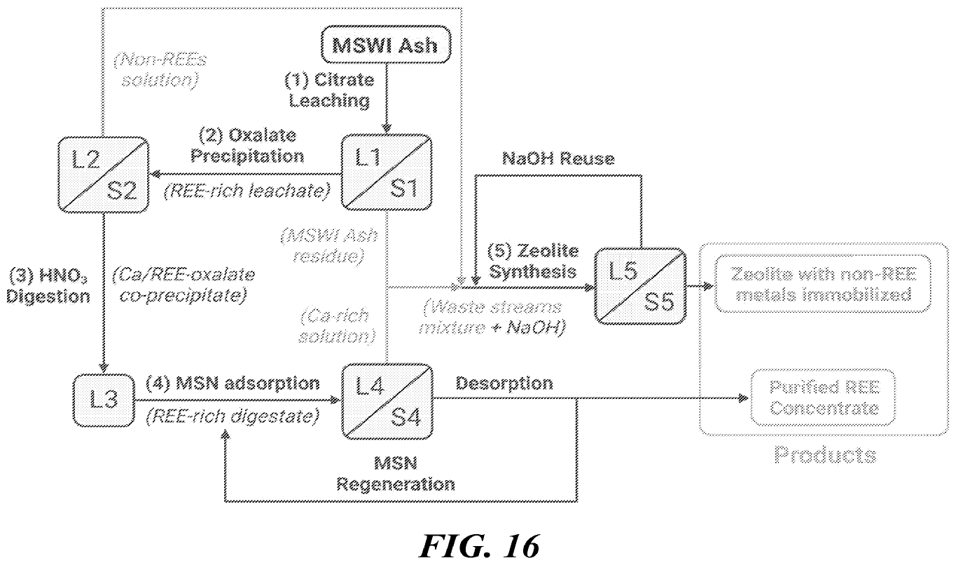

To minimize NaOH consumption and wastewater production during zeolite synthesis, the alkaline solution after one round of hydrothermal synthesis at 100° C. was tested for another round of zeolite synthesis without further addition of NaOH. It is found that zeolite yields are the same as the first round based on XRD analysis (FIGS. 15A-15B). Future experiments could be conducted to further minimize NaOH usage and optimize synthesis conditions.

System analysis and environmental significance. The simple but effective system reported in this study combines citrate leaching of CFA, preferential precipitation of REEs as oxalate products, and zeolite synthesis using the solid and liquid wastes from upstream steps. Compared to raw CFA samples, the oxalate products are 2-4 times more enriched in REEs (especially critical REEs) and contain fewer impurity elements such as Cr, Co, and Cu. Therefore, oxalate products could be regarded as a more promising REE feedstock for downstream REE purification to yield single-REE products. As for zeolite, previous studies showed that zeolite yields from CFA varied widely at 40-75%, depending on the glass content of CFA, non-reactive phases (e.g., hematite and lime), and resistant silicates (e.g., quartz and mullite)⁴⁸. This study produces near-pure zeolite products at 150° C., given that halite can be easily removed by washing. The citrate leaching experiment might serve as a pre-treatment process to remove non-reactive phases (such as hematite, lime, and periclase) prior to hydrothermal synthesis [51], and thus resulted in the high yields of zeolite in this study. Importantly, as all CFA solid residues are converted to zeolite, no solid residues will be produced from this system from the perspective of solid waste management. Wastewater from zeolite synthesis could be reused for synthesis to minimize wastewater production (FIGS. 15A-15B). By completely converting CFA to REE-enriched products and zeolite, this approach can bring about great economic and environmental benefits.

The system can be optimized to maximize economic and environmental benefits. For example, citrate concentration might be tailored for class F vs. C CFA to minimize citrate consumption. The remaining leachate after oxalate precipitation in module II can be recovered for other valuable metals (e.g., Cr, Co, Ni, Cu, and Zn). Cu and Zn could be preferentially precipitated by adding NaS₂ and adjusting pH [52]. In some embodiments, microbially produced citrate and oxalate may be used to replace chemicals and reduce operation costs. For example, Aspergillus niger is capable of producing citric acid or oxalic acid depending on the pH, Mn availability, and nitrogen limitation of the culture medium [53], [54], [55].

This system can be employed at various production and operational scales, including large-scale operations. Overall, the exemplary system and method address both resource recovery and solid waste management challenges with CFA. From the resource recovery aspect, this system can be characterized by the production of REE-rich oxalate products and zeolite. From the solid waste management aspect, the system can achieve maximum waste volume reduction and minimal production of wastewater.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] Dutta, T.; Kim, K.-H.; Uchimiya, M.; Kwon, E. E.; Jeon, B.-H.; Deep, A.; Yun, S.-T., Global demand for rare earth resources and strategies for green mining. Environmental Research 2016, 150, 182-190.
[2] Long, K. R.; Van Gosen, B. S.; Foley, N. K.; Cordier, D., The principal rare earth elements deposits of the United States: A summary of domestic deposits and a global perspective. In Non-Renewable Resource Issues, Springer: 2012; pp 131-155.
[3] Tracy, B., An Overview of Rare Earth Elements and Related Issues for Congress. Congressional Research Service 2020, (R46618), 1-16.
[4] Seredin, V. V.; Dai, S., Coal deposits as potential alternative sources for lanthanides and yttrium. International Journal of Coal Geology 2012, 94, 67-93.
[5] Franus, W.; Wiatros-Motyka, M. M.; Wdowin, M., Coal fly ash as a resource for rare earth elements. Environmental Science and Pollution Research 2015, 22, (12), 9464-9474.
[6] Taggart, R. K.; Hower, J. C.; Dwyer, G. S.; Hsu-Kim, H., Trends in the rare earth element content of US-based coal combustion fly ashes. Environmental science & technology 2016, 50, (11), 5919-5926.
[7] Dai, S.; Finkelman, R. B., Coal as a promising source of critical elements: Progress and future prospects. International Journal of Coal Geology 2018, 186, 155-164.
[8] Zhang, W.; Noble, A.; Yang, X.; Honaker, R., A comprehensive review of rare earth elements recovery from coal-related materials. Minerals 2020, 10, (5), 451.
[9] Seidler, M.; Malloy, K., A comprehensive survey of coal ash law and commercialization: Its environmental risks, disposal regulation, and beneficial use markets. National Association of Regulatory Utility Commissioners 2020, 1-94.
[10] EPA, Hazardous and solid waste management system; disposal of coal combustion residuals from electric utilities: Final rule. United States Environmental Protection Agency, Washington, D C 2015.
[11] Taggart, R. K.; Hower, J. C.; Hsu-Kim, H., Effects of roasting additives and leaching parameters on the extraction of rare earth elements from coal fly ash. International Journal of coal geology 2018, 196, 106-114.
[12] Peiravi, M.; Ackah, L.; Guru, R.; Mohanty, M.; Liu, J.; Xu, B.; Zhu, X.; Chen, L., Chemical extraction of rare earth elements from coal ash. Minerals & Metallurgical Processing 2017, 34, (4), 170-177.
[13] Smith, R. C.; Taggart, R. K.; Hower, J. C.; Wiesner, M. R.; Hsu-Kim, H., Selective recovery of rare earth elements from coal fly ash leachates using liquid membrane processes. Environmental science & technology 2019, 53, (8), 4490-4499.
[14] King, J. F.; Taggart, R. K.; Smith, R. C.; Hower, J. C.; Hsu-Kim, H., Aqueous acid and alkaline extraction of rare earth elements from coal combustion ash. International Journal of Coal Geology 2018, 195, 75-83.
[15] Middleton, A.; Park, D. M.; Jiao, Y.; Hsu-Kim, H., Major element composition controls rare earth element solubility during leaching of coal fly ash and coal by-products. International Journal of Coal Geology 2020, 227, 103532.
[16] Pan, J.; Hassas, B. V.; Rezaee, M.; Zhou, C.; Pisupati, S. V., Recovery of rare earth elements from coal fly ash through sequential chemical roasting, water leaching, and acid leaching processes. Journal of Cleaner Production 2021, 284, 124725.
[17] Stoy, L.; Diaz, V.; Huang, C.-H., Preferential Recovery of Rare-Earth Elements from Coal Fly Ash Using a Recyclable Ionic Liquid. Environmental Science & Technology 2021.
[18] Wang, K.; Adidharma, H.; Radosz, M.; Wan, P.; Xu, X.; Russell, C. K.; Tian, H.; Fan, M.; Yu, J., Recovery of rare earth elements with ionic liquids. Green Chemistry 2017, 19, (19), 4469-4493.
19. Park, D.; Middleton, A.; Smith, R.; Deblonde, G.; Laudal, D.; Theaker, N.; Hsu-Kim, H.; Jiao, Y., A biosorption-based approach for selective extraction of rare earth elements from coal byproducts. Separation and Purification Technology 2020, 241, 116726.
[20] Opare, E. O.; Struhs, E.; Mirkouei, A., A comparative state-of-technology review and future directions for rare earth element separation. Renewable and Sustainable Energy Reviews 2021, 143, 110917.
[21] Liu, P.; Huang, R.; Tang, Y., Comprehensive understandings of rare earth element (REE) speciation in coal fly ashes and implication for REE extractability. Environmental science & technology 2019, 53, (9), 5369-5377.
[22] Liu, P.; Yang, L.; Wang, Q.; Wan, B.; Ma, Q.; Chen, H.; Tang, Y., Speciation transformation of rare earth elements (REEs) during heating and implications for REE behaviors during coal combustion. International Journal of Coal Geology 2020, 219, 103371.
[23] Goyne, K. W.; Brantley, S. L.; Chorover, J., Rare earth element release from phosphate minerals in the presence of organic acids. Chemical Geology 2010, 278, (1-2), 1-14.
[24] Yang, J.; Montross, S.; Verba, C., Assessing the Extractability of Rare Earth Elements from Coal Preparation Fines Refuse Using an Organic Acid Lixiviant. Mining, Metallurgy & Exploration 2021, 1-9.
[25] Ji, B.; Li, Q.; Zhang, W., Leaching Recovery of Rare Earth Elements from Calcination Product of a Coal Coarse Refuse Using Organic Acids. Journal of Rare Earths 2020.
[26] Chung, D.-Y.; Kim, E.-H.; Lee, E.-H.; Yoo, J.-H., Solubility of rare earth oxalate in oxalic and nitric acid media. Journal of Industrial and Engineering Chemistry 1998, 4, (4), 277-284.
[27] Zhang, W.; Noble, A.; Ji, B.; Li, Q., Effects of contaminant metal ions on precipitation recovery of rare earth elements using oxalic acid. Journal of Rare Earths 2020.
[28] Liu, P.; Wang, Q.; Jung, H.; Tang, Y., Speciation, Distribution, and Mobility of Hazardous Trace Elements in Coal Fly Ash: Insights from Cr, Ni, and Cu. Energy & Fuels 2020, 34, (11), 14333-14343.
[29] Binnemans, K.; Jones, P. T.; Blanpain, B.; Van Gerven, T.; Pontikes, Y., Towards zero-waste valorisation of rare-earth-containing industrial process residues: a critical review. Journal of Cleaner Production 2015, 99, 17-38.
[30] Ju, T.; Han, S.; Meng, Y.; Jiang, J., High-End Reclamation of Coal Fly Ash Focusing on Elemental Extraction and Synthesis of Porous Materials. ACS Sustainable Chemistry & Engineering 2021, 9, (20), 6894-6911.
[31] Smith, R.; Martell, A.; Motekaitis, R., NIST standard reference database 46. NIST Critically Selected Stability Constants of Metal Complexes Database Ver 2004, 2.
[32] Parkhurst, D. L.; Appelo, C. Description of input and examples for PHREEQC version 3: a computer program for speciation, batch-reaction, one-dimensional transport, and inverse geochemical calculations; 2328-7055; US Geological Survey: 2013.
[33] Renew, J. E.; Huang, C.-H.; Burns, S. E.; Carrasquillo, M.; Sun, W.; Ellison, K. M., Immobilization of heavy metals by solidification/stabilization of co-disposed flue gas desulfurization brine and coal fly ash. Energy & Fuels 2016, 30, (6), 5042-5051.
[34] Klungness, G. D.; Byrne, R. H., Comparative hydrolysis behavior of the rare earths and yttrium: the influence of temperature and ionic strength. Polyhedron 2000, 19, (1), 99-107.
[35] Luo, Y.-R.; Byrne, R. H., Carbonate complexation of yttrium and the rare earth elements in natural waters. Geochimica et Cosmochimica Acta 2004, 68, (4), 691-699.
[36] Luo, Y.-R.; Byrne, R. H., Yttrium and rare earth element complexation by chloride ions at 25 C. Journal of Solution Chemistry 2001, 30, (9), 837-845.
[37] Schijf, J.; Byrne, R., Stability constants for mono-and dioxalato-complexes of Y and the REE, potentially important species in groundwaters and surface freshwaters. Geochimica et Cosmochimica Acta 2001, 65, (7), 1037-1046.
[38] Schijf, J.; Byrne, R. H., Determination of SO4β1 for yttrium and the rare earth elements at I=0.66 m and t=25 C-implications for YREE solution speciation in sulfate-rich waters. Geochimica et Cosmochimica Acta 2004, 68, (13), 2825-2837.
39. Haynes, W. M., CRC handbook of chemistry and physics. CRC press: 2014. [40] Diakonov, I.; Ragnarsdottir, K.; Tagirov, B., Standard thermodynamic properties and heat capacity equations of rare earth hydroxides: II. Ce (III)-, Pr-, Sm-, Eu (III)-, Gd-, Tb-, Dy-, Ho-, Er-, Tm-, Yb-, and Y-hydroxides. Comparison of thermochemical and solubility data. Chemical geology 1998, 151, (1-4), 327-347.
[41] Spahiu, K.; Bruno, J. A selected thermodynamic database for REE to be used in HLNW performance assessment exercises; Swedish Nuclear Fuel and Waste Management Co.: 1995.
[42] Winburn, R. S.; Grier, D. G.; McCarthy, G. J.; Peterson, R. B., Rietveld quantitative X-ray diffraction analysis of NIST fly ash standard reference materials. Powder Diffraction 2000, 15, (3), 163-172.
[43] Tazzoli, V.; Domeneghetti, C., The crystal structures of whewellite and weddellite: re-examination and comparison. American Mineralogist 1980, 65, (3-4), 327-334.
[44] Sandersius, S.; Rez, P., Morphology of crystals in calcium oxalate monohydrate kidney stones. Urological research 2007, 35, (6), 287-293.
[45] Zhao, S.; Jin, Q.; Sheng, Y.; Agrawal, A.; Guo, D.; Dong, H., Promotion of microbial oxidation of structural Fe (II) in nontronite by oxalate and NTA. Environmental Science & Technology 2020, 54, (20), 13026-13035.
[46] Lin, R.; Howard, B. H.; Roth, E. A.; Bank, T. L.; Granite, E. J.; Soong, Y., Enrichment of rare earth elements from coal and coal by-products by physical separations. Fuel 2017, 200, 506-520.
[47] Lin, R.; Stuckman, M.; Howard, B. H.; Bank, T. L.; Roth, E. A.; Macala, M. K.; Lopano, C.; Soong, Y.; Granite, E. J., Application of sequential extraction and hydrothermal treatment for characterization and enrichment of rare earth elements from coal fly ash. Fuel 2018, 232, 124-133.
[48] Querol, X.; Moreno, N.; Umaña, J. t.; Alastuey, A.; Hernindez, E.; Lopez-Soler, A.; Plana, F., Synthesis of zeolites from coal fly ash: an overview. International Journal of coal geology 2002, 50, (1-4), 413-423.
[49] Belviso, C., State-of-the-art applications of fly ash from coal and biomass: A focus on zeolite synthesis processes and issues. Progress in Energy and Combustion Science 2018, 65, 109-135.
[50] Henmi, T., Synthesis of hydroxy-sodalite (“zeolite”) from waste coal ash. Soil science and plant nutrition 1987, 33, (3), 517-521.
[51] Ju, T.; Meng, Y.; Han, S.; Lin, L.; Jiang, J., On the state of the art of crystalline structure reconstruction of coal fly ash: A focus on zeolites. Chemosphere 2021, 131010.
[52] Zhang, W.; Honaker, R., Process development for the recovery of rare earth elements and critical metals from an acid mine leachate. Minerals Engineering 2020, 153, 106382.
[53] Show, P. L.; Oladele, K. O.; Siew, Q. Y.; Aziz Zakry, F. A.; Lan, J. C.-W.; Ling, T. C., Overview of citric acid production from Aspergillus niger. Frontiers in Life Science 2015, 8, (3), 271-283.
[54] Strasser, H.; Burgstaller, W.; Schinner, F., High-yield production of oxalic acid for metal leaching processes by Aspergillus niger. FEMS Microbiology letters 1994, 119, (3), 365-370.
[55] Ruijter, G. J.; van de Vondervoort, P. J.; Visser, J., Oxalic acid production by Aspergillus niger: an oxalate-non-producing mutant produces citric acid at pH 5 and in the presence of manganese. Microbiology 1999, 145, (9), 2569-2576.

### SECOND REFERENCE SET

[1′] Parkhurst, D. L.; Appelo, C. Description of input and examples for PHREEQC version 3: a computer program for speciation, batch-reaction, one-dimensional transport, and inverse geochemical calculations; 2328-7055; US Geological Survey: 2013.
[2′] Smith, R.; Martell, A.; Motekaitis, R., NIST standard reference database 46. NIST Critically Selected Stability Constants of Metal Complexes Database Ver 2004, 2.
[3′] Haynes, W. M., CRC handbook of chemistry and physics. CRC press: 2014.
[4′] Luo, Y.-R.; Byrne, R. H., Yttrium and rare earth element complexation by chloride ions at 25 C. Journal of Solution Chemistry 2001, 30, (9), 837-845.
[5′] Klungness, G. D.; Byrne, R. H., Comparative hydrolysis behavior of the rare earths and yttrium: the influence of temperature and ionic strength. Polyhedron 2000, 19, (1), 99-107.
[6′] Luo, Y.-R.; Byrne, R. H., Carbonate complexation of yttrium and the rare earth elements in natural waters. Geochimica et Cosmochimica Acta 2004, 68, (4), 691-699.
[7′] Schijf, J.; Byrne, R. H., Determination of SO4β1 for yttrium and the rare earth elements at I=0.66 m and t=25 C-implications for YREE solution speciation in sulfate-rich waters. Geochimica et Cosmochimica Acta 2004, 68, (13), 2825-2837.
[8′] Schijf, J.; Byrne, R., Stability constants for mono-and dioxalato-complexes of Y and the REE, potentially important species in groundwaters and surface freshwaters. Geochimica et Cosmochimica Acta 2001, 65, (7), 1037-1046.
[9′] Diakonov, I.; Ragnarsdottir, K.; Tagirov, B., Standard thermodynamic properties and heat capacity equations of rare earth hydroxides: II. Ce (III)-, Pr-, Sm-, Eu (III)-, Gd-, Tb-, Dy-, Ho-, Er-, Tm-, Yb-, and Y-hydroxides. Comparison of thermochemical and solubility data. Chemical geology 1998, 151, (1-4), 327-347.
[10′] Spahiu, K.; Bruno, J. A selected thermodynamic database for REE to be used in HLNW performance assessment exercises; Swedish Nuclear Fuel and Waste Management Co.: 1995.
[11′] Chung, D.-Y.; Kim, E.-H.; Lee, E.-H.; Yoo, J.-H., Solubility of rare earth oxalate in oxalic and nitric acid media. Journal of Industrial and Engineering Chemistry 1998, 4, (4), 277-284.
[12′] Zhao, Y.; Li, J.; Zhang, S.; Wang, X. Amidoxime-functionalized magnetic mesoporous silica for selective sorption of U(vi). RSC Advances 2014, 4 (62), 32710-32717, 10.1039/C4RA05128A. DOI: 10.1039/C4RA05128A.
[13′] Zhang, F.; Lan, J.; Zhao, Z.; Yang, Y.; Tan, R.; Song, W. Removal of heavy metal ions from aqueous solution using Fe3O4-SiO2-poly(1,2-diaminobenzene) core-shell sub-micron particles. Journal of Colloid and Interface Science 2012, 387 (1), 205-212. DOI: https://doi.org/10.1016/j.jcis.2012.07.066.
[14′] Lin, Y.-S.; Haynes, C. L. Synthesis and Characterization of Biocompatible and Size-Tunable Multifunctional Porous Silica Nanoparticles. Chemistry of Materials 2009, 21 (17), 3979-3986. doi: 10.1021/cm901259n.
[15′] Chen, X.; Lam, K. F.; Zhang, Q.; Pan, B.; Arruebo, M.; Yeung, K. L. Synthesis of Highly Selective Magnetic Mesoporous Adsorbent. The Journal of Physical Chemistry C 2009, 113 (22), 9804-9813. doi: 10.1021/jp9018052.

What is claimed is:

1. A method for recovering rare earth elements (REE) from a waste ash source, the method comprising:
contacting a REE-containing waste ash source with a chelating agent, thereby forming a leachate comprising one or more REE and a first residual material;
contacting a precipitation agent with the leachate to form a second residual material and a solid precipitate comprising an amount of the one or more REE;
separating the solid precipitate from the second residual material; and
hydrothermally treating the first and/or second residual materials under conditions effective to yield a processed material comprising zeolites.

2. The method of claim 1, wherein the REE-containing waste ash source comprises coal fly ash (CFA), municipal solid waste incineration (MSWI) ash, industrial solid waste incineration ash, or a combination thereof.

3. The method of any of claims 1-2, wherein the REE-containing waste ash source comprises coal fly ash (CFA).

4. The method of any of claims 1-3, wherein the REE-containing waste ash source comprises 5% or more SiO₂ by weight.

5. The method of any of claims 1-4, wherein the chelating agent comprises an acid or salt thereof.

6. The method of any of claims 1-5, wherein the chelating agent comprises citric acid or a salt thereof.

7. The method of claim 6, wherein the citric acid or salt thereof is contacted with the REE-containing waste ash source at a concentration of 25 mM to 150 mM.

8. The method of any of claims 1-7, wherein the REE-containing waste ash source is contacted with the chelating agent at a pH of 7.0 or less.

9. The method of any of claims 1-8, wherein the precipitation agent comprises an organic ligand.

10. The method of any of claims 1-9, wherein the solid precipitate comprises an REE-oxalate.

11. The method of any of claims 1-10, further comprising contacting the first residual material with the second residual material prior to or during hydrothermal treatment.

12. The method of any of claims 1-11, wherein the first and/or second residual material are contacted with an alkaline solution prior to or during hydrothermal treatment.

13. The method of any of claims 1-12, wherein the hydrothermal treating of the first and/or second residual material occurs at a temperature of from 50° C. to 300° C.

14. The method of any of claims 1-13, further comprising substantially separating the zeolites from the processed material to form a zeolite-rich product and a depleted waste material.

15. The method of claim 14, wherein the zeolite-rich product comprises 75% or more zeolites by weight.

16. The method of any of claims 1-15, further comprising substantially separating a purified REE-product from the solid precipitate.

17. The method of claim 16, wherein the step of substantially separating the purified REE-product comprises dissolving the solid precipitate comprising the amount of one or more REE in a solvent and recovering the purified REE-product.

18. The method claim 17, wherein the purified REE-product is adsorbed using functionalized magnetic mesoporous silica particles.

19. The method of any of claims 1-18, wherein the method is performed continuously or semi-continuously.

20. The method of any of claims 1-18, wherein the method is performed batchwise.

21. A method for processing a residual waste ash material, the method comprising:
hydrothermally treating a residual waste ash material comprising a concentration of aluminosilicates under conditions effective to yield a processed waste ash material comprising zeolites, wherein the residual waste ash material was collected as a byproduct from the removal of a heavy metal from a prior process; and
substantially separating the zeolites from the processed waste material, thereby forming a zeolite-rich product and a depleted waste material.

22. A method for recovering rare earth elements (REE) from a waste ash source, the method comprising:
contacting a REE-containing waste ash source with a chelating agent, thereby forming a leachate comprising one or more REE and a first residual material;
adding a precipitation agent to the leachate to form a second residual material and a solid precipitate comprising an amount of the one or more REE;
separating the solid precipitate from the second residual material; and
using the first and/or second residual materials to produce porous metal oxide particles.

23. A system comprising: components to perform the method of any of claims 1-22.

24. A system for recovering rare earth elements from a REE-containing waste source, the system comprising:
a first reactor configured to receive the REE-containing waste ash source and a chelating agent, and wherein the first reactor is configured to produce a leachate comprising one or more REE and a first residual material; and
a second reactor configured to receive the leachate and a precipitation agent, wherein the second reactor is configured to produce a second residual material and a solid precipitate comprising an amount of the one or more REE.

25. The system of claim 24, further comprising a third reactor configured to receive the first and/or second residual materials, wherein the third reactor operates under conditions effective to produce a processed waste material comprising zeolites.

26. The system of any of claims 24-25, wherein the REE-containing waste ash source comprises coal fly ash (CFA), municipal solid waste incineration (MSWI) ash, or a combination thereof.

27. The system of any of claims 24-26, wherein the REE-containing waste ash source comprises coal fly ash (CFA).

28. The system of any of claims 24-27, wherein the REE-containing waste ash source comprises 5% or more SiO₂ by weight.

29. The system of any of claims 24-28, wherein the chelating agent comprises an acid.

30. The system of any of claims 24-29, wherein the chelating agent comprises citric acid or a salt thereof.

31. The system of claim 30, wherein a concentration of citric acid or salt thereof in the first reactor is from 25 mM to 150 mM.

32. The system of any of claims 24-31, wherein the first reactor is configured to operate at a pH of 7.0 or less.

33. The system of any of claims 24-32, wherein the precipitation agent comprises an organic ligand.

34. The system of any of claims 24-33, wherein the solid precipitate comprises an REE-oxalate.

35. The system of any of claims 25-34, wherein the third reactor is configured to operate at a temperature of 50° C. to 300° C.

36. The system of any of claims 24-35, further comprising a separation unit configured to receive the solid precipitate and a solvent, wherein the separation unit produces a purified REE-product and a third residual material.

37. The system of claim 36, wherein the separation unit comprises an adsorption column or reactor comprising an adsorbent.

38. The system of any of claims 36-37, wherein the third reactor is configured to receive the first, second, and third residual materials.

39. The system of any of claims 24-38, wherein the system is configured to operate continuously or semi-continuously.

40. The system of any of claims 24-38, wherein the system is configured to operate batchwise.
